(19) United States
(12) Patent Application Publication
(10) Pub. No.: US 2025/0209065 A1
(43) Pub. Date: Jun. 26, 2025

(54) METHOD OF PERFORMING DATA ANALYSIS ACCORDING TO NATURAL LANGUAGE QUERY BY USING GENERATIVE ARTIFICIAL INTELLIGENCE, AND ELECTRONIC DEVICE FOR PERFORMING THE SAME

(71) Applicant: Samsung Electronics Co., Ltd., Suwon-si (KR)

(72) Inventors: Byunguk CHOI, Suwon-si (KR); Heechang RYU, Suwon-si (KR); Kangwook LEE, Suwon-si (KR)

(73) Assignee: Samsung Electronics Co., Ltd., Suwon-si (KR)

(21) Appl. No.: 18/999,303

(22) Filed: Dec. 23, 2024

Related U.S. Application Data
(63) Continuation of application No. PCT/KR2024/097048, filed on Dec. 17, 2024.

(30) Foreign Application Priority Data
Dec. 20, 2023 (KR) 10-2023-0187565

(51) Int. Cl. G06F 16/242; G06F 16/21; G06F 16/248

(52) U.S. Cl. CPC G06F 16/243; G06F 16/212; G06F 16/248

(57) ABSTRACT

A method of performing data analysis according to a natural language query from a user includes: receiving, from a user terminal, a user input including the natural language query requesting the data analysis; determining, based on the user input, at least one database among a plurality of databases as a target database; generating a prompt based on the user input and the target database; inputting the prompt into a code generation model to obtain a structured query (SQL) statement; executing the SQL statement to generate a result of the data analysis on the target database; and transmitting the result of the data analysis to the user terminal, where the result of the data analysis is displayed on a screen of the user terminal.

### CROSS-REFERENCE TO RELATED APPLICATION(S)

This application is a continuation of PCT International Application No. PCT/KR2024/097048, which was filed on Dec. 17, 2024, and claims priority to Korean Patent Application No. 10-2023-0187565, filed on Dec. 20, 2023, in the Korean Intellectual Property Office, the disclosures of each of which are incorporated by reference herein their entirety.

### BACKGROUND

### 1. Field

The disclosure relates to a method of performing data analysis according to a user's natural language query, and more particularly, to a method of performing analysis of data stored in a database by, when a user requests data analysis in natural language, generating a structured query language (SQL) statement corresponding to the request by using a generative artificial intelligence (AI) model, and executing the SQL statement, and an electronic device and a system for performing the method.

### 2. Description of Related Art

Currently, vast amounts of data are being produced in various fields, and the amount of data being produced is increasing. In order to utilize data, the data needs to be analyzed according to a certain purpose or criteria, and a structured query language (SQL) statement is needed to analyze data stored in a database. However, for general users without specialized knowledge of SQL, it is difficult to directly write an SQL statement without specialized training, which is time consuming and expensive.

In a case where a system or service is implemented to perform data analysis according to a user's request even when the user requests data analysis via a natural language query, the system or the service may improve user convenience and enable more users to utilize data.

### DISCLOSURE

### Technical Solution

According to an aspect of the disclosure, a method of performing data analysis according to a natural language query from a user includes: receiving, from a user terminal, a user input including the natural language query requesting the data analysis; determining, based on the user input, at least one database among a plurality of databases as a target database; generating a prompt based on the user input and the target database; inputting the prompt into a code generation model to obtain a structured query (SQL) statement; executing the SQL statement to generate a result of the data analysis on the target database; and transmitting the result of the data analysis to the user terminal, in which the result of the data analysis is displayed on a screen of the user terminal.

According to an aspect of the disclosure, an electronic device for performing data analysis according to a natural language query from a user, the electronic device includes: memory storing one or more instructions; and at least one processor operatively coupled to the memory, wherein the one or more instructions, when executed by the at least one processor, cause the electronic device to: receive, from a user terminal, a user input including the natural language query requesting the data analysis, determine, based on the user input, at least one database among a plurality of databases as a target database, generate a prompt based on the user input and the target database, input the prompt into a code generation model to obtain a structured query (SQL) statement, and execute the SQL statement to generate a result of the data analysis on the target database; and transmit the result of the data analysis to the user terminal, wherein the result of the data analysis is displayed on a screen of the user terminal.

According an aspect of the disclosure, a computer-readable recording medium may have stored therein a program for executing, on a computer, the method according to at least one of the embodiments of the disclosure.

According an aspect of the disclosure, a computer program may be stored in a medium so as to perform the method according to at least one of the embodiments of the disclosure, on a computer.

### DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating a system for performing data analysis according to a user's natural language query, according to one or more embodiments of the disclosure.

FIG. 2 is a diagram illustrating hardware components included in an electronic device of FIG. 1;

FIG. 3 is a diagram illustrating a method of training a code generation model, according to one or more embodiments of the disclosure;

FIG. 4 is a diagram illustrating a method of training a similarity determination model, according to one or more embodiments of the disclosure;

FIG. 5 is a diagram illustrating raw code data for training a code generation model, according to one or more embodiments of the disclosure;

FIG. 6 is a diagram illustrating a result of performing preprocessing on the raw code data of FIG. 5 for training, according to one or more embodiments;

FIG. 7 is a diagram illustrating instruction tuning data for training a code generation model, according to one or more embodiments of the disclosure;

FIG. 8 is a diagram illustrating a user interface (UI) screen for allowing a user to select an analysis history that is displayed in the process of performing a data analysis method, according to one or more embodiments of the disclosure;

FIG. 9 is a diagram illustrating analysis history data stored in a history storage of a system, according to one or more embodiments of the disclosure;

FIG. 10 is a diagram illustrating a situation in which details of an analysis history are displayed on a UI screen for selecting an analysis history, according to one or more embodiments of the disclosure;

FIG. 11 is a diagram illustrating a UI screen for allowing a user to enter a natural language query requesting data analysis, which is displayed in the process of performing a data analysis method, according to one or more embodiments of the disclosure;

FIG. 12 illustrates metadata of databases, according to one or more embodiments of the disclosure;

FIGS. 13A to 13C are diagrams illustrating UI screens on which metadata and tables of databases are displayed, according to one or more embodiments of the disclosure;

FIG. 14 is a diagram illustrating a method of determining a target database based on determination of similarity in the process of performing a data analysis method, according to one or more embodiments of the disclosure;

FIG. 15 is a diagram illustrating a structure of a prompt generated in the process of performing a data analysis method, according to one or more embodiments of the disclosure;

FIG. 16 is a diagram illustrating details of a portion related to analysis history 1 included in the prompt of FIG. 15, according to one or more embodiments;

FIG. 17 is a diagram illustrating details of a portion related to analysis history 2 included in the prompt of FIG. 15, according to one or more embodiments;

FIG. 18 is a diagram illustrating details of a portion related to a current natural language query included in the prompt of FIG. 15, according to one or more embodiments;

FIG. 19 is a diagram illustrating an example in which a code generation model generates a structured query language (SQL) statement when a prompt is input to the code generation model in the process of performing a data analysis method, according to one or more embodiments of the disclosure;

FIG. 20 is a diagram illustrating a UI screen that outputs a data analysis result by executing an SQL statement in the process of performing a data analysis method, according to one or more embodiments of the disclosure;

FIG. 21 illustrates a method of visualizing results of data analysis in graphs or charts in the process of performing a data analysis method, according to one or more embodiments of the disclosure;

FIG. 22 is a flowchart of a method of analyzing data according to a user's natural language query, according to one or more embodiments of the disclosure; FIG. 23 is a flowchart illustrating detailed operations included in an operation 2201 of FIG. 22, according to one or more embodiments;

FIG. 24 is a flowchart illustrating detailed operations included in an operation 2202 of FIG. 22, according to one or more embodiments;

FIG. 25 is a flowchart illustrating detailed operations included in an operation 2203 of FIG. 22, according to one or more embodiments and;

FIG. 26 is a flowchart illustrating detailed operations included in an operation 2205 of FIG. 22, according to one or more embodiments.

### DETAILED DESCRIPTION

Throughout the disclosure, the expression “at least one of a, b or c” indicates only a, only b, only c, both a and b, both a and c, both b and c, all of a, b, and c, or variations thereof.

In describing the disclosure, descriptions of technical ideas that are well known in a technical field to which the disclosure pertains and are not directly related to the disclosure will be omitted. This is to more clearly convey the essence of the disclosure without obscuring it by omitting unnecessary descriptions. Furthermore, the terms used hereinafter are defined by taking into account functions described in the disclosure and may be changed according to a user's or operator's intent, practices, or the like. Therefore, definition of the terms should be made based on the overall description of the disclosure.

For the same reason, in the accompanying drawings, some components are exaggerated, omitted, or schematically illustrated. Also, the size of each component does not entirely reflect the actual size. In the drawings, like reference numerals refer to the same or corresponding elements throughout.

Advantages and features of the disclosure and methods of accomplishing the same will be more readily appreciated by referring to the following description of embodiments of the disclosure and the accompanying drawings. However, the disclosure may be embodied in many different forms and should not be construed as being limited to the embodiments of the disclosure set forth below. Rather, the embodiments of the disclosure are provided so that the disclosure will be made thorough and complete and will fully convey the scope of the disclosure to those of ordinary skill in the art to which the disclosure pertains. One or more embodiments of the disclosure may be defined by the appended claims. Throughout the specification, like reference numerals refer to like elements. Furthermore, in the following description of the disclosure, related functions or configurations will not be described in detail when it is determined that they would obscure the essence of the disclosure with unnecessary detail. Furthermore, terms used hereinafter are defined by taking into account functions described in the disclosure and may be changed according to a user's or operator's intent, practices, or the like. Therefore, definition of the terms should be made based on the overall description of the disclosure.

In one or more embodiments of the disclosure, each block in flowchart illustrations and combinations of blocks in the flowchart illustrations may be performed by computer program instructions. These computer program instructions may be loaded into a processor of a general-purpose computer, a special-purpose computer, or other programmable data processing equipment, and the instructions executed by the processor of the computer or the other programmable data processing equipment may generate a unit for performing functions specified in the flowchart block(s). The computer program instructions may also be stored in a computer-executable or computer-readable memory configured to direct the computer or the other programmable data processing equipment to implement functions in a specific manner, and the instructions stored in the computer-executable or computer-readable memory are configured to produce an article of manufacture including instructions for performing the functions specified in the flowchart block(s). The computer program instructions may also be loaded into the computer or the other programmable data processing equipment.

In addition, each block of a flowchart may represent a module, segment, or portion of code that includes one or more executable instructions for executing specified logical function(s). In one or more embodiments of the disclosure, functions mentioned in blocks may occur out of order. For example, two blocks illustrated in succession may be executed substantially simultaneously, or the blocks may sometimes be executed in reverse order depending on functions corresponding thereto.

As used in one or more embodiments of the disclosure, the term ‘unit’ refer to a software element or a hardware element such as a field-programmable gate array (FPGA) or an application-specific integrated circuit (ASIC), and may perform a predetermined function. However, the term ‘unit’ is not limited to software or hardware. The ‘unit’ may be configured to be in an addressable storage medium or configured to operate one or more processors. In one or more embodiments of the disclosure, the term ‘unit’ may include elements such as software elements, object-oriented software elements, class elements, and task elements, processes, functions, attributes, procedures, sub-routines, segments of program code, drivers, firmware, micro-codes, circuits, data, a database, data structures, tables, arrays, and parameters. Functions provided by a specific element or a specific unit may be combined to reduce the number of elements or may be further divided into additional elements. In addition, in one or more embodiments of the disclosure, a ‘unit’ may include one or more processors.

Hereinafter, examples meanings of the terms used herein is described.

In one or more examples, “generative artificial intelligence (AI)” may refer to a type of AI technology configured to generate new text, images, etc. in response to input data (e.g. text, images, etc.). A representative example of generative AI is described in the description of “generative model” below.

In one or more examples, a “generative model” may refer to a neural network model that implements a generative Al technology. The generative model is configured to generate new data having similar characteristics to input data or new data corresponding to the input data by learning patterns and structures in training data. For example, when the input data is text containing a question, the generative model may generate and output an answer to the question. In one or more examples, when the input data is text containing a request, the generative model may output text or images generated in response to the request. A ‘code generation model’ according to one or more embodiments of the disclosure is a generative model that generates and outputs code (an SQL statement) when taking as input a prompt generated based on a user's input (e.g., selection of an analysis history, a natural language query, etc.). Instead of a ‘generative model’ or ‘code generation model’, terms such as a ‘generative AI model’, a ‘language model’, and a ‘neural network model’ may be used.

In one or more examples, a “natural language query” may refer to text in natural language that is input to request the performance of a specific operation or request specific information. According to one or more embodiments of the disclosure, a user may input a natural language query requesting data analysis to a system or electronic device for performing data analysis. Instead of a “natural language query,” terms such as a “natural language instruction,” a “natural language input,” a “natural language request,” an “analysis query,” an “analysis request,” an “instruction,” etc., may also be used.

In one or more examples, a “structured query language (SQL) statement” may refer to code written according to SQL syntax to perform data analysis. For reference, SQL may refer to a standard search language that enables users to connect to databases. For example, an SQL statement may include instructions to aggregate, extract, classify, or sort information (e.g. data values) contained in a database according to specific criteria. According to one or more embodiments of the disclosure, an electronic device may request information from a database via an SQL statement. Furthermore, according to one or more embodiments of the disclosure, the electronic device may perform analysis on data stored in the database by executing the SQL statement on the database. According to one or more embodiments of the disclosure, a code generation model, which is a generative AI model, may generate SQL statements. Terms such as an “SQL query, “SQL based request,” “query,” “code,” etc., may be used instead of an “SQL statement.” As understood by one of ordinary skill in the art, the embodiments of the present disclosure are not limited SQL, and may include any suitable database language known to one of ordinary skill in the art.

In one or more examples “database” may refer to a space where data is stored. According to one or more embodiments of the disclosure, a “table” generated using data may be stored in a “database.” According to one or more embodiments of the disclosure, a “database” may also refer to a “table” generated using data stored therein. According to one or more embodiments of the disclosure, may be a relational database (RDB), and an RDB may refer to a collection of tables consisting of rows and columns while having relationships with other tables. Data stored in an RDM may be referred to as a relational table.

In one or more examples, “target database” may refer to a database in which data to be subjected to analysis is stored. According to one or more embodiments of the disclosure, the electronic device may select a target database from among a plurality of databases based on a user's input (e.g. selection of an analysis history and a natural language query), and generate an SQL statement and perform data analysis based on the selected target database. Terms such as an ‘analysis database’, an ‘associated database’, a ‘related database’, etc. may also be used instead of a ‘target database’.

In one or more examples, “database management system (or DBMS)” may refer to a configuration that manages a database, thereby providing an environment where application programs may share and use the database. In general, application programs do not directly manipulate a database, but there is separate software that manipulates the database, which may be referred to a database management system.

In one or more examples, “analysis history” may refer to analysis task previously performed on data. Analysis histories may be organized in a hierarchical structure, with an analysis history of a lower layer (a child layer) also including an analysis task corresponding to an analysis history of a higher layer (a parent layer). This is described in detail below with reference to the drawings. “Data corresponding to analysis history” may be stored in a system or electronic device according to one or more embodiments of the disclosure, and the data corresponding to the analysis history may include a name of an analysis task, a natural language query entered when performing the analysis task, an SQL statement generated when performing the analysis task, a result of execution of the SQL statement, etc. Instead of an “analysis history,” terms such as “analysis task,” “analysis work,” “history,” etc., may also be used.

In one or more examples “metadata” in a database may refer to data used to describe the database. Metadata may include a table catalog and a table schema.

In one or more examples, “table catalog” may include a description of a table included in the database (e.g., what information is stored in the table) and a description of each column in the table. A specific example of a table catalog is described in detail below with reference to the drawings.

In one or more examples, “table schema” may be information that defines the structure and rules of a table included in the database. For example, the table schema may refer to a logical structure that represents how information is stored within the database. For example, a table schema may include information about what tables to create, what columns are included in each table, what constraints are on each column, and how to create relationships between tables. According to one or more embodiments of the disclosure, the table schema may include instructions created to generate a table. A specific example of a table schema is described in detail below with reference to the drawings.

Hereinafter, embodiments of the disclosure are described in detail with reference to the drawings.

Embodiments of the disclosure relate to a method of performing data analysis by, when the user requests data analysis in natural language, generating an SQL statement corresponding to the request by using a generative AI model, and executing the generated SQL statement on a database, and an electronic device and system for performing the method.

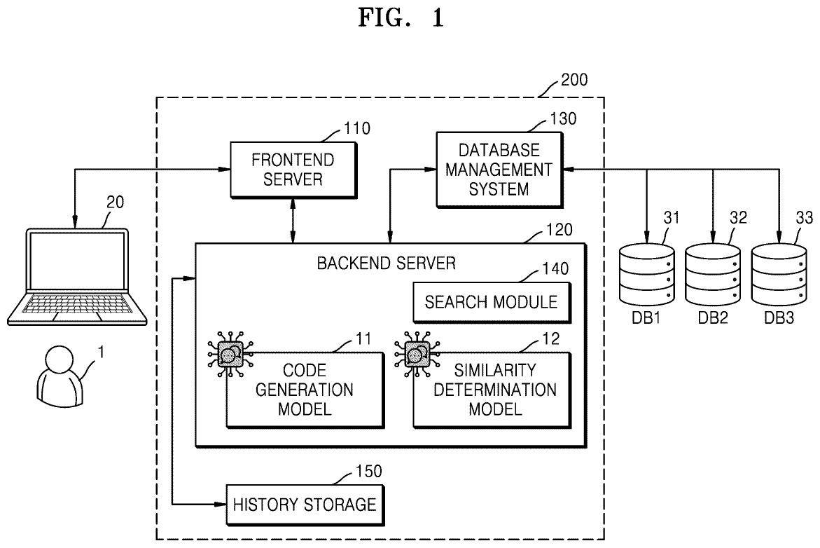

FIG. 1 is a diagram illustrating a system for performing data analysis according to a user's natural language query, according to one or more embodiments of the disclosure.

Referring to FIG. 1, a system according to one or more embodiments of the disclosure may include a user terminal 20, an electronic device 200, and a plurality of databases DB1 31, DB2 32, and DB 33, and the electronic device 200 may include a frontend server 110, a backend server 120, a database management system 130, a search module 140, a history storage 150, a code generation model 11, and a similarity determination model 12.

The user terminal 20 may be a device that provides a user 1 with an interface for data analysis. The user 1 may request data analysis via the input/output (I/O) interface (e.g., a display panel, a keyboard, a mouse, etc.) of the user terminal 20 and check a result of the data analysis. In the disclosure, user interface (UI) screens (UI screens illustrated in the drawings) output in the process of performing data analysis may be displayed on the user terminal 20 at the request of the electronic device 200. According to one or more embodiments of the disclosure, an application or program for data analysis may be installed on the user terminal 20, and when the user 1 executes the application or program, the user terminal 20 may access the electronic device 200 to request execution of processes for the data analysis. The user terminal 20 may be implemented as various types of electronic devices, and for example, a laptop, a desktop PC, a tablet, a mobile phone etc. may be used as the user terminal 20.

Various types of data to be subjected to analysis in embodiments of the disclosure may be stored in the plurality of databases DB1 31, DB2 32, and DB3 33. According to one or more embodiments of the disclosure, each of the plurality of databases DB1 31, DB2 32, and DB3 33 may store at least one table generated using data. The plurality of databases DB1 31, DB2 32, and DB3 33 may be controlled by the database management system 130.

The electronic device 200 is a device for analyzing data stored in the databases DB 1 31, DB 2 32, and DB3 33 in response to a request from the user 1 received via the user terminal 20.

The code generation model 11, the similarity determination model 12, the frontend server 110, the backend server 120, the database management system 130, the search module 140, and the history storage 150 (hereinafter, referred to as ‘detailed components’) included in the electronic device 200 of FIG. 1 are components classified based on their functions or roles. In FIG. 1, the electronic device 200 is shown to include all of the detailed components, and in practice, the electronic device 200 may be implemented to include all of them. However, the electronic device 200 is not limited thereto, each of the detailed components may be implemented as an independent hardware device, two or more of the detailed components may be integrated, or one of the detailed components may be implemented to be included in another detailed component. As understood by one of ordinary skill in the art, each the servers illustrated in FIG. 1 may be implemented by one or more servers. Furthermore, the databases DB 1 31, DB 2 32, and DB3 33 may be remotely located from the electronic device 200.

In one or more examples, the frontend server 110 and the backend server 120 may each be independent hardware devices, or they may be hardware/software components included in one hardware device. If the frontend server 110 and the backend server 120 are implemented as independent hardware devices, the electronic apparatus 200 may be an electronic system. The backend server 120 may be configured to include the code generation model 11, the similarity determination model 12, and the search module 140, as illustrated in FIG. 1.

In one or more examples, the history storage 150 may be a separate memory device for storing data, or may be implemented to be included in the backend server 120.

In one or more examples, the code generation model 11 may refer to an independent hardware device executing a generative AI model for generating code, or may refer to a generative AI model executed by the backend server 120. Also, for example, the similarity determination model 12 may refer to an independent hardware device executing an AI model for determining a degree of similarity between text data, or may refer to an AI model executed by the backend server 120.

In one or more examples, the database management system 130 may be implemented as a single independent server and may include the plurality of databases DB1 31, DB2 32, and DB3 33.

According to one or more embodiments of the disclosure, some of the detailed components may be implemented to be included in the user terminal 20.

As described above, according to one or more embodiments of the disclosure, the detailed components included in the system may be hardware components or software components, and may be implemented in the form of various electronic devices (e.g., one electronic device or a combination of two or more electronic devices).

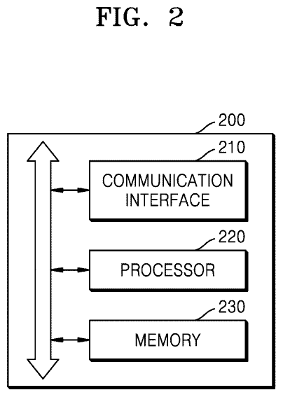

In the disclosure, embodiments of the disclosure are described by assuming that the electronic device 200 includes all of the detailed components. Accordingly, operations described below as being performed by the detailed components of FIG. 1 may be considered as being performed by a processor 220 of FIG. 2 of the electronic device 200 shown in FIG. 2 executing a program or at least one instruction stored in memory (230 of FIG. 2).

FIG. 2 is a diagram illustrating hardware components included in an electronic device 200. Referring to FIG. 2, according to one or more embodiments of the disclosure, the electronic device 200 may include a communication interface 210, a processor 220, and a memory 230. However, the components of the electronic device 200 are not limited to the example described above, and the electronic device 200 may include more or fewer components than the components described above. Some or all of the communication interface 210, the processor 220, and the memory 230 may be implemented in the form of a single chip. According to one or more embodiments of the disclosure, the electronic device 200 may be a server operated by a provider of data analysis services. In one or more examples, the electronic device 200 corresponds to the user terminal 20. In one or more examples, the electronic device 200 may be functionally similar to the electronic device 200, where the processor 220 performs the functions of the frontend server 110, the backend server 120, and the database management system 130, and the memory 230 stores the same information as the history storage 150.

In one or more examples, the communication interface 210 is a component for transmitting and receiving signals (control commands, data, etc.) to and from an external device by wire or wirelessly, and may be implemented to include a communication chipset that supports various communication protocols. The communication interface 210 may receive a signal from the outside and output the signal to the processor 220, or transmit a signal output from the processor 220 to the outside. The electronic device 200 may communicate with the user terminal 20 or the plurality of databases DB1 31, DB2 32, and DB3 33 via the communication interface 210.

In one or more examples, the electronic device 200 may transmit information for displaying a UI screen to the user terminal 20 via the communication interface 210, and receive an input for requesting data analysis from the user terminal 20. Furthermore, the electronic device 200 may access at least one of the plurality of databases DB1 31, DB2 32, and DB3 33 via the communication interface 210 to perform data analysis and obtain results of the data analysis.

In one or more examples, the processor 220 is a component that controls a series of processes to cause the electronic device 200 to operate according to embodiments of the disclosure as described below, and may be configured as one or more processors. The one or more processors included in the processor 220 may be circuitry, such as a system on chip (SoC), an integrated circuit (IC), or the like. The one or more processors included in the processor 220 may be general-purpose processors such as a central processing unit (CPU), a microprocessor unit (MPU), an application processor (AP), a digital signal processor (DSP), etc., dedicated graphics processors such as a graphics processing unit (GPU) and a vision processing unit (VPU), dedicated AI processors such as a neural processing unit (NPU), or dedicated communication processors such as a communication processor (CP). When the one or more processors included in the processor 220 are a dedicated AI processor, the corresponding AI dedicated processor may be designed with a hardware structure specialized for processing a specific AI model.

The processor 220 may write data to the memory 230 or read data stored in the memory 230, and in particular, execute a program or at least one instruction stored in the memory 230 to process data according to predefined operation rules or Al models. Thus, the processor 220 may perform operations according to embodiments of the disclosure as described below, and operations described as being performed by the electronic device 200 or the detailed components (e.g., the code generation model 11 to the history storage 150) included in the electronic 100 in the embodiments of the disclosure as described below may be considered as being performed by the processor 220 unless otherwise specified.

In one or more examples, the memory 230 is a component for storing various programs or data, and may consist of a storage medium, such as read-only memory (ROM), random access memory (RAM), a hard disk, compact disc ROM (CD-ROM), and a digital video disc (DVD), or a combination of storage media. The memory 230 may not exist separately but may be configured to be included in the processor 220. The memory 230 may consist of volatile memory, non-volatile memory, or a combination of volatile memory and non-volatile memory. The memory 230 may store a program or at least one instruction for performing operations according to embodiments of the disclosure as described below. The memory 230 may provide stored data to the processor 220 according to a request from the processor 220.

According to embodiments of the disclosure, when the user 1 inputs a natural language query requesting analysis of data via the user terminal 20, the electronic device 200 may generate an SQL statement corresponding to the natural language query by using the code generation model 11 and perform data analysis by executing the generated SQL statement on the databases DB1 31, DB2 32, and DB3 33. In one or more examples, a natural language query may be a query that allows users to use ordinary human language such as “retrieve all data generated in the past month,” etc. Hereinafter, embodiments of the disclosure in which the electronic device 200 performs data analysis according to a user's natural language query are described in detail.

First, roles of the two neural network models, e.g., the code generation model 11 and the similarity determination model 12, included in the electronic device 200 and a method of training the two neural network models are described, and then, operations of generating an SQL statement corresponding to the natural language query by the trained two neural network models and performing data analysis are described.

### 1. 1. Role and Training of the Code Generation Model 11

According to one or more embodiments, the code generation model 11 may be a generative AI model for generating an SQL statement (code) corresponding to a natural language query from the user 1. A prompt input to the code generation model 11 may include the natural language query input by the user 1, and further include data corresponding to an analysis history (e.g., a previous analysis task) selected by the user 1 and metadata (e.g., a table catalog and a table schema) of a target database.

According to one or more embodiments of the disclosure, the target database may be determined based on the natural language query input by the user 1. Additionally, according to one or more embodiments of the disclosure, the target database may be determined based on the natural language query input by the user 1 and an analysis history selected by the user 1. An example method of generating a prompt input to the code generation model 11 and an example of a prompt are described in detail below with reference to the corresponding drawings.

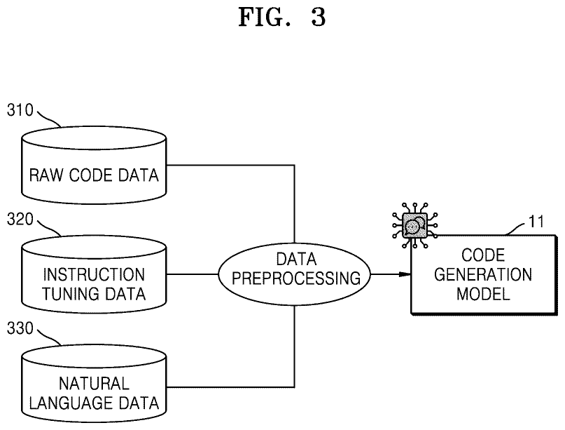

FIG. 3 is a diagram illustrating a method of training the code generation model 11, according to one or more embodiments of the disclosure. Referring to FIG. 3, raw code data 310, instruction tuning data 320, and natural language data 330 may be used to train the code generation model 11, and preprocessing for increasing training efficiency may be performed on at least some of the training data 310, 320, and 330.

### (1) Collection of Training Data

In one or more examples, raw code data 310 may be data used to train a model on what format code generally follows. Because the code generation model 11 needs to generate code, various types of code may be used to train the code generation model 11 to learn the general format of code.

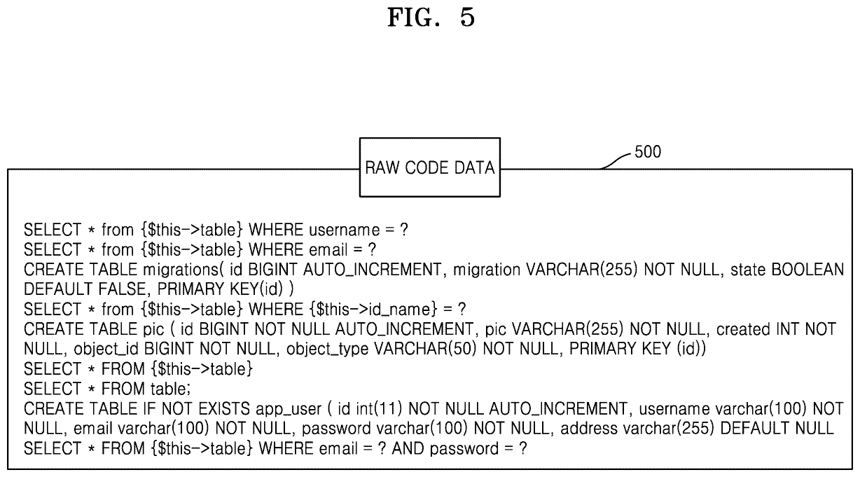

An example of the raw code data 310 is shown in FIG. 5. Referring to FIG. 5, raw code data 500 may include various codes (e.g., SQL statements) randomly collected. According to one or more embodiments of the disclosure, the raw code data 500 may be collected from a repository where various codes are stored, such as Github, or the like. As understood by one of ordinary skill in the art, the codes are not limited to SQL, and may include any suitable code known for one of ordinary skill in the art for querying a database.

In one or more examples, the instruction tuning data 320 may be data used to learn which code (SQL statement) corresponds to an instruction in natural language. Training the code generative model 11 by using the instruction tuning data 320 may be a concept of semantically aligning a code to a natural language instruction. Because the instruction tuning data 320 is training data for fine-tuning, the instruction tuning data 320 may be configured to include a much smaller amount of data than the raw code data 310.

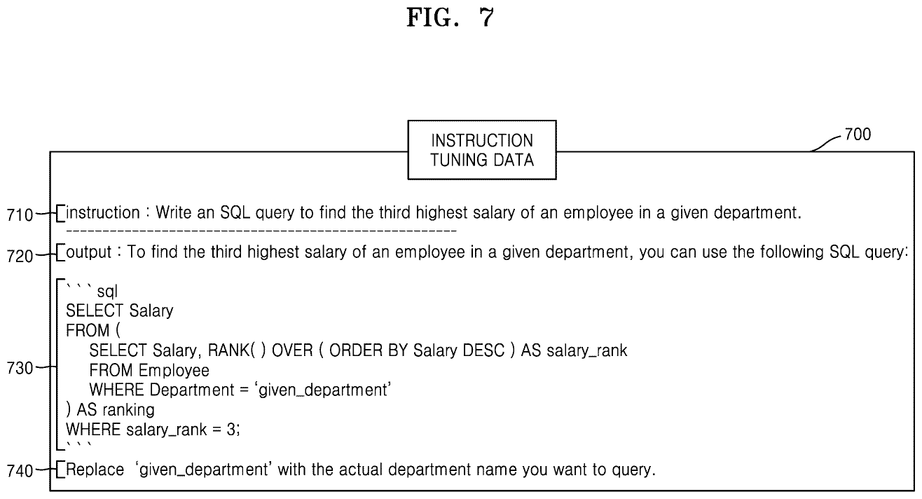

An example of the instruction tuning data 320 is illustrated in FIG. 7. Referring to FIG. 7, instruction tuning data 700 may include a natural language instruction 710, an annotation 720, an SQL statement 730, and an annotation 740. The instruction tuning data 700 may be collected to include a pair of the natural language instruction 710 and the corresponding SQL statement 730. The annotations 720 and 740 may be text describing a task or situation and may be generated according to a preset format and criteria. In one or more examples, the instruction tuning data 320 may be supervised data in which the annotations are predetermined and added to the instruction tuning data 320. In one or more examples, the instruction tuning data 320 may be unsupervised data in which the annotations are not predetermined, but instead, may be derived using any AI model (e.g., large language model) that is trained to accept a natural language query and output the annotations.

The code generation model 11 may be trained using the instruction tuning data 320 to operate as a chat model that allows the user 1 to issue commands in natural language.

The natural language data 330 may be a collection of texts in natural language that may be used when training a general language model. Because the code generation model 11 basically corresponds to a language model that processes natural language, training may also be performed using the natural language data 330. According to one or more embodiments of the disclosure, the natural language data 330 may be collected from various sources on the Internet.

### (2) Preprocessing Training Data

According to one or more embodiments, preprocessing for increasing training efficiency may be performed on at least some of the training data described above, (e.g., the raw code data 310), the instruction tuning data 320, and the natural language data 330.

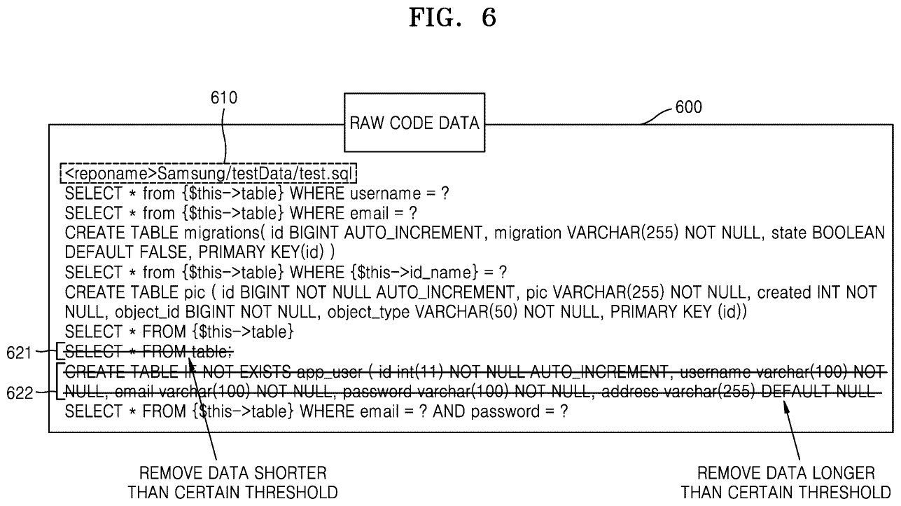

According to one or more embodiments of the disclosure, preprocessing may be performed on the raw code data 310, as described with reference to FIG. 6.

FIG. 6 is a diagram illustrating a result of performing preprocessing for training on the raw code data 500 of FIG. 5. Referring to preprocessed raw code data 600 shown in FIG. 6, it can be seen that the following preprocessing operations have been performed.

1) Removing Code that is too Short or too Long

Data 621 that is shorter than a certain threshold and data 622 that is longer than another threshold were removed because they may adversely affect training.

### 2) Appending a Title Including a Repository Name and a Storage Path to a Front

To transform the raw code data 600 into a form suitable for training, a title 610 consisting of a repository name, a storage path, and a file name is added to a front of the raw code data 600. In this case, the file name may be determined to infer what function the file (raw code data) does, and a file extension may be set to a specific predetermined value (e.g., “.sql”) to clearly indicate that the file is about SQL statements.

In one or more examples, duplicate data may be removed from the data included in the raw code data 600.

According to one or more embodiments of the disclosure, preprocessing may also be performed on the natural language data 330. For example, in the natural language data 330, parts that are not helpful for natural language learning, such as special characters or abbreviations, may be removed via preprocessing.

### (3) Performing Training Using Training Data

The code generation model 11 may be trained using the training data, e.g., the raw code data 310, the instruction tuning data 320, and the natural language data 330, collected and preprocessed as described above.

A method of training the code generation model 11 by using the raw code data 310 is as follows. Referring to the preprocessed raw code data 600 in FIG. 6, the code generation model 11 may be trained to infer tokens that constitute the remainder of the code at the back of the raw code data 600 when given a portion of the code at the front of the raw code data 600.

A method of training the code generation model 11 by using the instruction tuning data 320 is as follows. Referring to the instruction tuning data 700 in FIG. 7, the code generation model 11 may be trained to infer the annotation 720, the SQL statement 730, and the annotation 740 that follow, when given the natural language instruction 710 at the beginning of the instruction tuning data 700.

A method of training the code generation model 11 by using the natural language data 330 is as follows. When given a first portion of the natural language data 330, the code generation model 11 may be trained to infer the remaining portion.

The code generation model 11 may be trained according to any of the methods described above, and the training of the code generation model 11 may be performed by the electronic device 200 or by another external device.

### 2. Role and Training of the Similarity Determination Model 12

According to one or more embodiments, the similarity determination model 12 may be a neural network model for determining a degree of similarity between data. The similarity determination model 12 may be used to determine a target database to be subjected to analysis from among the plurality of databases DB1 31, DB2 32, and DB3 33. According to one or more embodiments of the disclosure, the search module 140 may measure a degree of similarity between an input from the user 1 (e.g., a natural language query and selection of an analysis history) and metadata of each of the databases DB1 31, DB2 32, and DB3 33 by using the similarity determination model 12, and select a target database based on a result of the measurement.

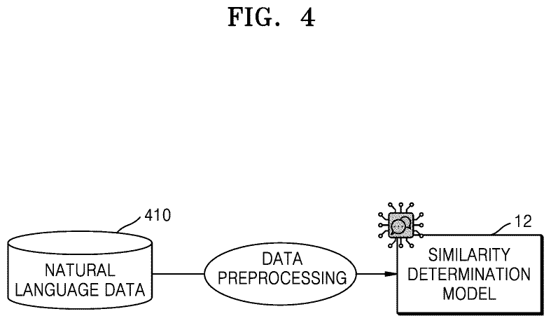

To perform this role, the similarity determination model 12 may be trained to measure similarity (e.g., calculate a similarity score) between text data. Thus, the similarity determination model 12 may be trained using natural language data 410 as shown in FIG. 4.

Descriptions provided above with respect to the training of the code generation model 11 using the natural language data 330 may be equally applicable to collection and preprocessing of the natural language data 410 used for training the similarity determination model 12, and training of the similarity determination model 12 using the natural language data 410.

According to one or more embodiments of the disclosure, the similarity determination model 12 may be implemented as an encoder.

### 3. A Brief Description of the Overall Process of Performing Data Analysis in Response to a Natural Language Query

According to one or more embodiments of the disclosure, when the user 1 inputs a natural language query via the user terminal 20, the electronic device 200 may generate a prompt based on the natural language query, obtain an SQL statement generated by the code generation model 11 by inputting the generated prompt to the code generation model 11, and then perform data analysis by executing the SQL statement. In one or more examples, the prompt may be the natural language query (e.g., text string) that is converted to a format suitable for the code generation model. For example, the prompt may include the text string and any additional data the code generation model 11 may use to generate the SQL statement.

That is, according to one or more embodiments of the disclosure, when the user 1 simply inputs a query requesting data analysis in natural language, the electronic device 200 may perform data analysis by automatically generating an SQL statement corresponding to the query.

Hereinafter, operations performed step by step by the detailed components (, the code generation model 11, the similarity determination model 12, the frontend server 110, the backend server 120, the database management system 130, the search module 140, and the history storage 150) included in the electronic device 200 are described in detail.

### 4. Receiving a User Input (Selection of an Analysis History and a Natural Language Query)

The frontend server 110 may provide a UI screen for receiving a user input requesting data analysis to the user 1 via the user terminal 20, receive a user input from the user terminal 20, and transmit the user input to the backend server 120.

According to one or more embodiments of the disclosure, the user input that the electronic device 200 receives from the user 1 may include, for example, only a natural language query requesting data analysis. In this case, the electronic device 200 may perform processes such as selecting a target database, generating an SQL statement, etc., based on the natural language query received from the user 1.

According to one or more embodiments of the disclosure, the user input that the electronic device 200 receives from the user 1 may further include an input for selecting an analysis history as well as a natural language query requesting data analysis. In this case, the electronic device 200 may perform processes such as selecting a target database, generating SQL statements, etc., based on the analysis history selected by the user 1 and the natural language query input by the user 1. The electronic device 200 may more faithfully reflect an intent of the user 1 and improve work efficiency by using the analysis history selected by the user 1. The embodiments of the disclosure are described by assuming that a user input that the electronic device 100 receives from the user 1 includes both an input for selecting an analysis history and a natural language query requesting data analysis. However, as understood by one of ordinary skill in the art, the embodiments are not limited to these configurations.

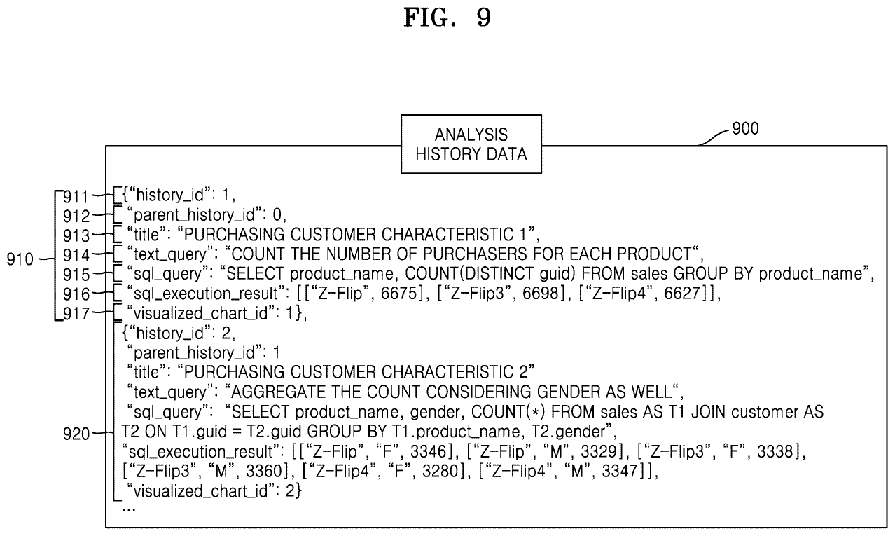

The frontend server 110 and the backend server 120 may provide a history of previously performed analysis tasks to the user 1 via a UI screen. According to one embodiment of the disclosure, the frontend server 110 and the backend server 120 may first output a UI screen for logging in via the user terminal 20, and when the user 1 successfully logs in, may retrieve data about analysis histories stored in the history storage 150, and control a UI screen for selecting one of the analysis histories to be displayed on the user terminal 20. Data corresponding to analysis histories stored in the history storage 150 (hereinafter referred to as ‘analysis history data’) is described in detail below with reference to FIG. 9.

The reason that the electronic device 200 allows the user 1 to select an analysis history is as follows. A natural language query entered by the user 1 alone may not sufficiently reflect an intent of the user 1, and the electronic device 200 may more accurately determine the intent of the user 1 via the analysis history selected by the user 1. Furthermore, the electronic device 200 may increase work efficiency by using a result of a previously performed analysis task (e.g., an analysis task corresponding to the analysis history selected by the user 1) when analyzing data according to the natural language query entered by the user 1.

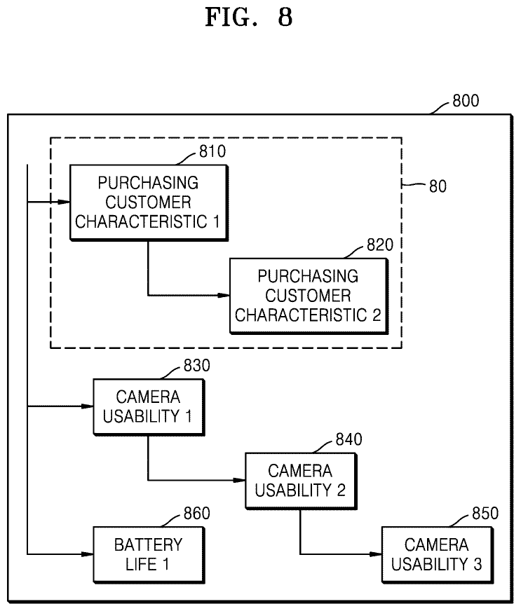

An example of a UI screen for the user 1 to select an analysis history is illustrated in FIG. 8. Referring to FIG. 8, a plurality of analysis histories (e.g., analysis history 1 810, analysis history 2 820, and analysis histories 830, 840, 850, and 860), are displayed on a first UI screen 800. The analysis histories displayed on the first UI screen 800 may be information stored to correspond to an account of the logged in user 1, or may also be information shared by all users using the system. For example, when the user 1 logs in, analysis tasks previously performed by the user 1 may be displayed as analysis histories, or all analysis tasks previously performed by all users including the user 1 may be displayed as analysis histories.

Hereinafter, for convenience of description, a purchasing customer characteristic 1 is referred to as “analysis history 1 810,” and a purchasing customer characteristic 2 is referred to as “analysis history 2 820.”

FIG. 9 illustrates an example of analysis history data stored in the history storage 150. The analysis history data 900 shown in FIG. 9 may include a first portion 910 corresponding to an analysis task in the analysis history 1 810 of FIG. 8, and a second portion 920 corresponding to an analysis task in the analysis history 2 820. The analysis history 1 810 corresponds to an analysis history of a higher layer above the analysis history 2 820. As described above, an analysis history in a lower layer may also include an analysis task corresponding to an analysis history in a higher layer. The analysis history data 900 illustrated in FIG. 9 is data corresponding to the analysis history 2 820, and may therefore also include information about the analysis task corresponding to the analysis history 1 810 that is a higher layer above the analysis history 2 820.

Referring to FIG. 9, the first portion 910 of the analysis history data 900 may include an ID 911 for identifying the history, an ID 912 for identifying a history of a higher layer (a previous history), a title 913 of the analysis history, a natural language query entered when performing the analysis task included in the analysis history 914, an SQL statement 915 generated by the code generation model 11 when performing the analysis task included in the analysis history, a result 916 of the execution of the SQL statement 915, and an ID 917 for identifying a graph visualizing a result of data analysis. The second portion 920 of the analysis history data 900 may also have the same structure as the first portion 910.

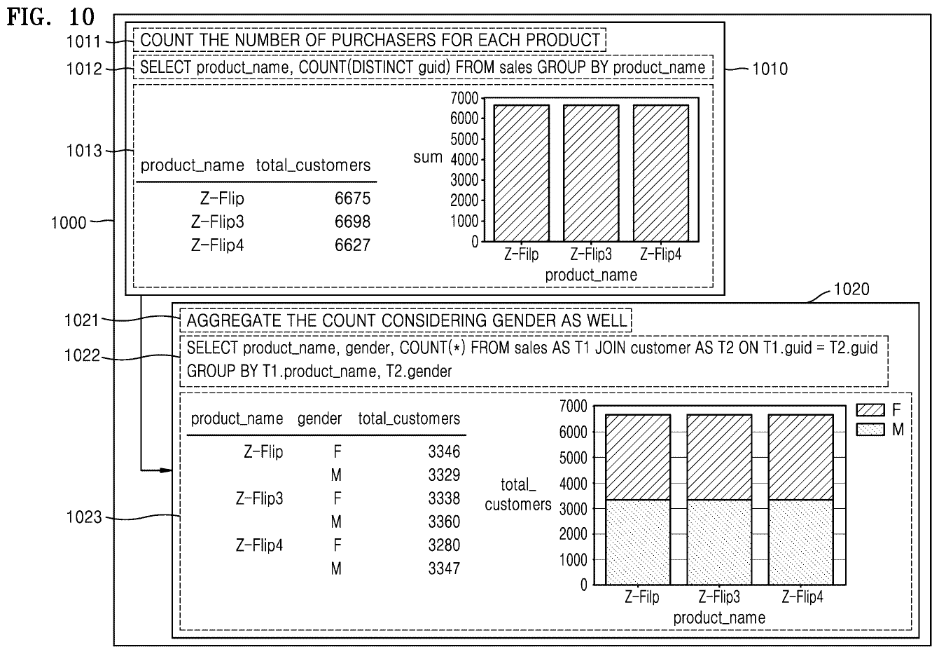

The user 1 may select at least one of the plurality of analysis histories (e.g., 810, 820, 830, 840, 850, and 860) via the first UI screen 800. For example, the user 1 may view names of the plurality of analysis histories (e.g., 810, 820, 830, 840, 850, and 860) displayed on the first UI screen 800 and select one of them. In one or more examples, the user 1 may view details of a corresponding analysis history and then select the analysis history. According to one or more embodiments of the disclosure, when the user 1 enlarges a first region 80 of the first UI screen 800, the frontend server 110 and the backend server 120 may control the user terminal 20 to display details of the analysis history 1 810 and the analysis history 2 820 included in the first region 80. A UI screen displayed when the user 1 enlarges the first region 80 of the first UI screen 800 is illustrated in FIG. 10.

FIG. 10 is a diagram illustrating a situation in which details of analysis histories are displayed on a UI screen for selecting an analysis history, according to one or more embodiments of the disclosure. Referring to FIG. 10, details of analysis history 1 1010 and details of analysis history 2 1020 may be displayed on a second UI screen 1000.

The details of the analysis history 1 1010 may include a natural language query 1011 entered when performing an analysis task corresponding to the analysis history 1 1010, an SQL statement 1012 generated based on the corresponding natural language query 1011, and a result 1013 of the execution of the SQL statement 1012. The result 1013 of the execution of the SQL statement 1012 may include a table representing a result of the data analysis and a graph visualizing the result.

Similarly, the details of the analysis history 2 1020 may include a natural language query 1021 entered when performing an analysis task corresponding to the analysis history 2 1020, an SQL statement 1022 generated based on the natural language query 1021, and a result 1023 of the execution of the SQL statement 1022.

The user 1 may check the details of the analysis histories 1010 and 1020 via the second UI screen 1000 and select the analysis history to be reflected in the data analysis. In one or more embodiments of the disclosure, the subsequent processes are described by assuming that the user 1 selects the analysis history 2 1020.

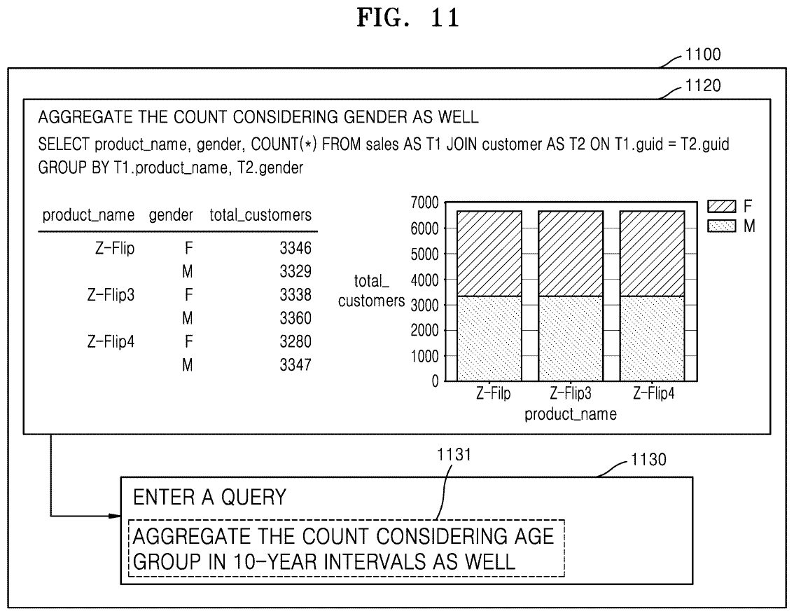

When the user 1 selects the analysis history 2 1020 on the second UI screen 1000, the frontend server 110 and the backend server 120 may control an input window for entering a natural language query to be displayed on the user terminal 20. A UI screen with an input window for entering a natural language query is shown in FIG. 11.

FIG. 11 is a diagram illustrating a UI screen for allowing a user to enter a natural language query requesting data analysis. Referring to FIG. 11, the third UI screen 1100 may display details of the analysis history 2 1120 selected by the user 1, and an input window 1130 for entering a natural language query. The user 1 may enter a natural language query 1131 requesting data analysis via the input window 1130.

In accordance with the process described above, the user 1 may select an analysis history to be reflected in data analysis, and then enter a natural language query requesting the data analysis.

### 5. Selecting a Target Database

According to one or more embodiments, the frontend server 110 receives a user input (e.g., selection of an analysis history and a natural language query) via the user terminal 20, the frontend server 110 may transmit the user input to the backend server 120, and the backend server 120 may transmit data related to the user input to the search module 140, requesting the search module 140 to select a target database. At this time, the backend server 120 may obtain metadata of the databases DB1 31, DB2 32, and DB3 33 from the database management system 130 and transmit the metadata to the search module 140.

The search module 140 may select at least one of the databases DB1 31, DB2 32, and DB3 33 as a target database by using the data related to the user input and the metadata of the databases DB1 31, DB2 32, and DB3 33. For example, the search module 140 may determine a target database to be used for analysis, based on the analysis history selected by the user 1 and the natural language query entered by the user 1.

In detail, the search module 140 may measure a degree of similarity between natural language data related to the user input (e.g., a natural language query included in the selected analysis history, the natural language query entered by the user 1, etc.) and the metadata of each of the plurality of databases DB1 31, DB2 32, and DB3 33 by using the similarity determination model 12, and select a target database based on the measured degree of similarity.

According to one or more embodiments of the disclosure, the ‘natural language data related to the user input’ may include at least one natural language query related to the analysis history selected by the user 1 (e.g., a natural language query entered when performing at least one analysis task included in the selected analysis history) and the natural language query entered by the user 1. According to one or more embodiments of the disclosure, the “natural language data related to the user input” may include only the natural language query entered by the user 1. In one or more examples, “natural language data related to a user input” includes at least one natural language query related to an analysis history selected by the user 1 and a natural language query entered by the user 1.

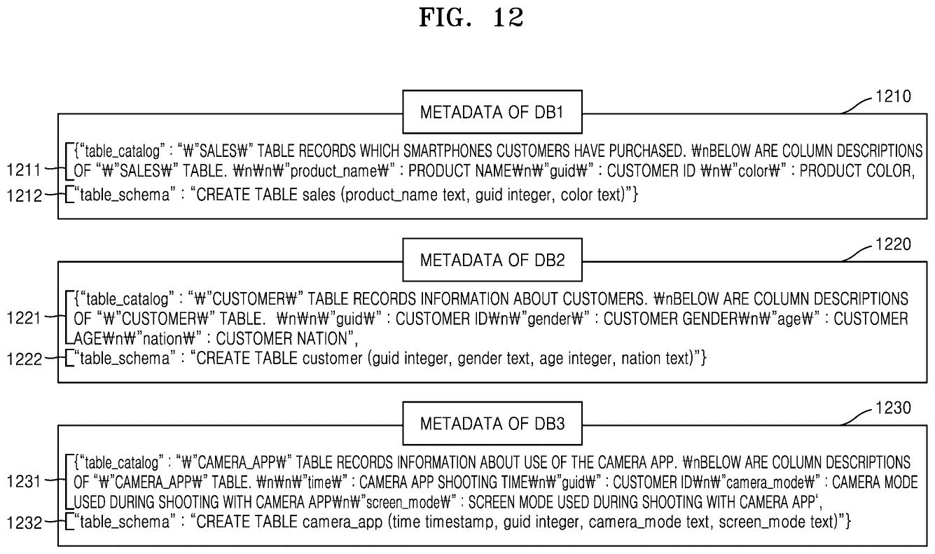

A process in which the search module 140 selects a target database by using the similarity determination model 12 is described in detail with reference to FIGS. 12 to 14.

FIG. 12 illustrates example metadata of each of the plurality of databases DB1 31, DB2 32, and DB3 33. As described above, metadata of each of the databases DB1 31, DB2 32, and DB3 33 may include a table catalog and a table schema. A table catalog and a table schema are described in detail with reference to FIG. 12.

Referring to FIG. 12, metadata 1210 of database DB1 31 may include a table catalog 1211 and a table schema 1212.

The table catalog 1211 may include a description of a table included in the database DB1 31 (e.g., what information is stored in the table). Furthermore, the table catalog 1211 may include a description of each column of the table included in the database DB1 31 (e.g., what each column of the table represents). As seen in the table catalog 1211 in FIG. 12, a table named “sales” included in the database DB1 31 stores information about which smartphones customers have purchased, the names of columns in the table are “product name”, globally unique identifier “guid”, and “color”, respectively, and pieces of information recorded in the columns are respectively ‘name of product’, ‘customer ID’, and ‘color of product’.

The table schema 1212 may define a structure and rules of the table included in the database DB1 31. For example, referring to FIG. 12, the table schema 1212 may include instructions for creating a table, and thus, may include information about what table to create, what columns are included in each table, what constraints are on each column, etc. As seen in the table schema 1212 in FIG. 12, a table named “sales” is created in the database DB1 31, the names of columns in the table are respectively “product name”, “guid”, and “color”, and types of information recorded in the columns are text, integer, and text, respectively.

FIG. 12 also illustrates metadata 1220 of the database DB2 32 and metadata 1230 of the database DB3 33. The metadata 1220 of the database DB2 32 may also include a table catalog 1221 and a table schema 1222, and the metadata 1230 of the database DB3 33 may also include a table catalog 1231 and a table schema 1232. Because the metadata 1220 of the database DB2 32 and the metadata 1230 of the database DB3 33 have similar forms and characteristics to the metadata 1210 of the database DB1 31, detailed descriptions thereof are omitted.

According to one or more embodiments of the disclosure, the backend server 120 may retrieve the metadata of the databases DB1 31, DB2 32, and DB3 33 from the database management system 130 whenever necessary. According to one or more embodiments of the disclosure, the backend server 120 may update the metadata of the databases DB1 31, DB2 32, and DB3 33 on a local memory (e.g., a cache memory in the backend server 120) at regular intervals and obtain the metadata through caching the metadata as needed, thereby improving metadata retrieval performance and speed.

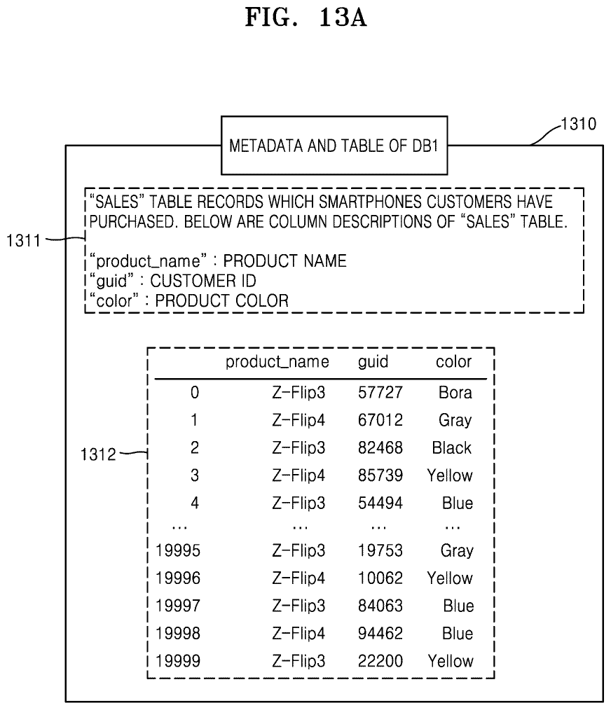

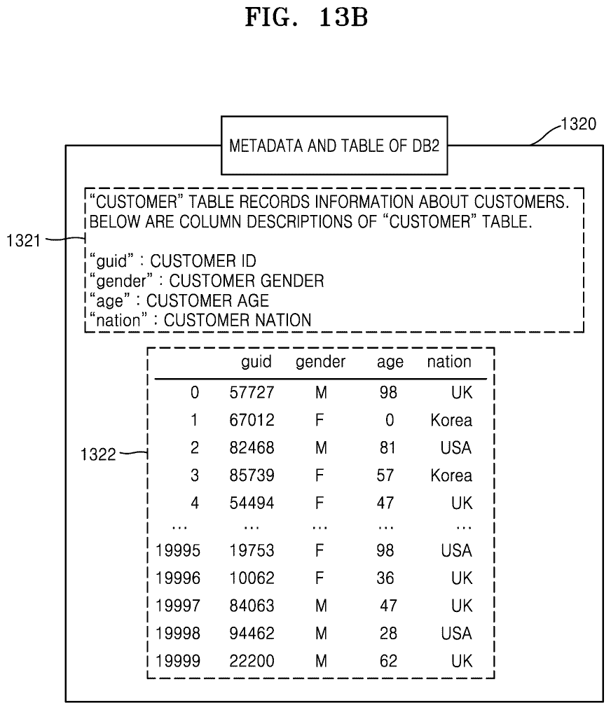

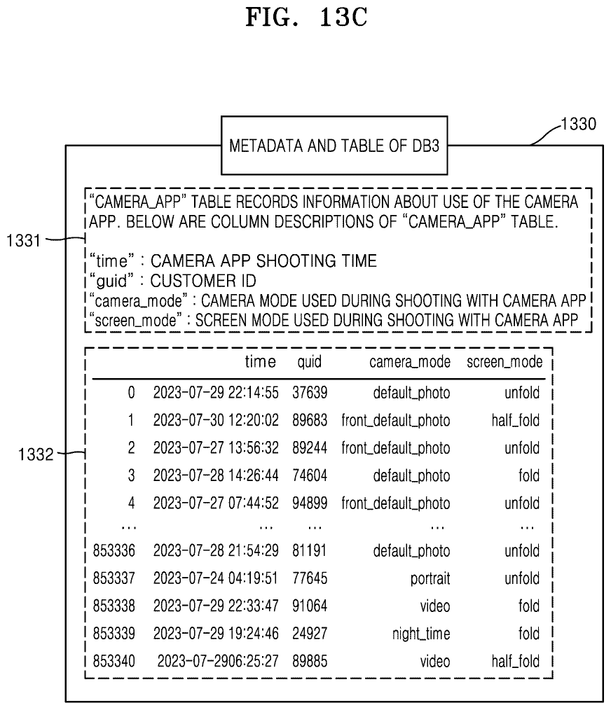

FIGS. 13A to 13C are diagrams illustrating UI screens on which metadata and tables of databases are displayed, according to one or more embodiments of the disclosure. When necessary, the frontend server 110 and the backend server 120 may control UI screens of FIGS. 13A to 13C (UI screens corresponding to the databases DB1 31, DB2 32, and DB3 33, respectively) to be displayed on the user terminal 20. For example, when a target database is selected by the search module 140, the frontend server 110 and the backend server 120 may control a UI screen corresponding to the selected target database to be displayed on the user terminal 20. In one or more examples, the frontend server 110 and the backend server 120 may control a UI screen corresponding to a database not selected as the target database by the search module 140 to be displayed on the user terminal 20, thereby providing the user 1 with an opportunity to directly select a target database.

According to one or more embodiments of the disclosure, the backend server 120 may display UI screens corresponding to databases selected by the search module 140 in such a manner as to be distinguished from UI screens corresponding to the other databases (e.g., by displaying them in a different size, brightness, etc.), thereby allowing the user 1 to view a result of the selection by the search module 140. In this case, the user 1 may exclude some of the databases selected by the search module 140 from the target database, or conversely, allow some of the databases not selected by the search module 140 to be included in the target database.

In one or more examples, a UI screen 1310 corresponding to the database DB1 31 shown in FIG. 13A may include a table catalog 1311 of the database DB1 31 and a table 1312 corresponding to the database DB1 31. As described above, the table catalog 1311 may include a description of the table 1312 and a description of each column in the table 1312. Because the table 1312 includes table values respectively corresponding to columns for each of a plurality of entities (components corresponding to rows), and the table 1312 is generated according to the structure and rules determined by the table schema, the UI screen 1310 may be considered as including the table schema and the table values.

Similarly, a UI screen 1320 corresponding to the database DB2 32 shown in FIG. 13B may include a table catalog 1321 of the database DB2 32 and a table 1322 corresponding to DB2 32. Furthermore, a UI screen 1330 corresponding to the database DB3 33 shown in FIG. 13C may include a table catalog 1331 of the database DB3 33 and a table 1332 corresponding to the database DB3 33. Because the UI screen 1320 corresponding to the database DB2 32 and the UI screen 1330 corresponding to the database DB3 33 have similar forms and characteristics to the UI screen 1310 corresponding to the database DB1 31, detailed descriptions thereof are omitted.

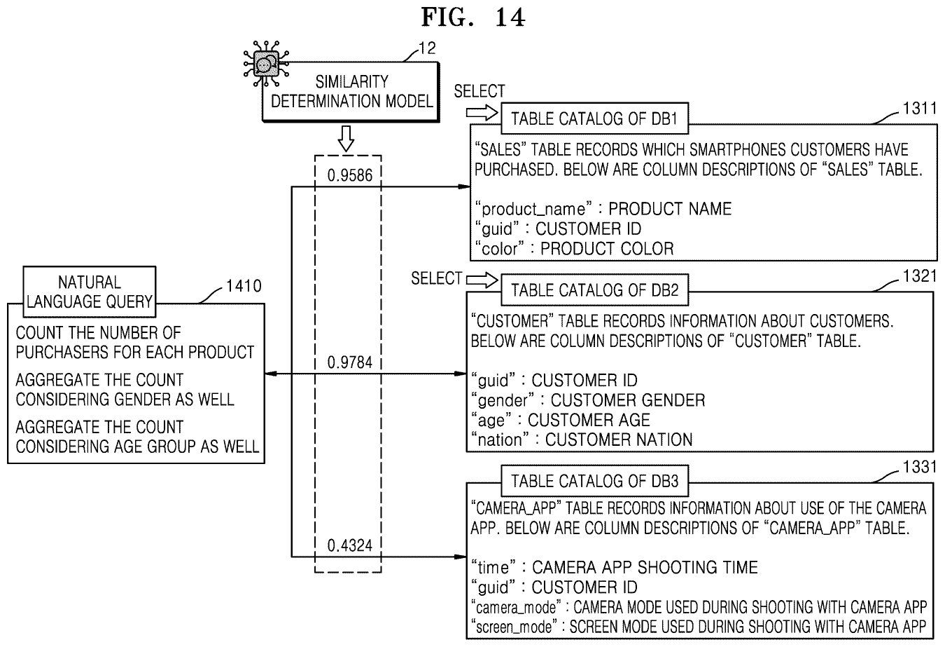

FIG. 14 is a diagram illustrating a method of determining a target database based on determination of similarity in the process of performing a data analysis method, according to one or more embodiments of the disclosure.

Referring to FIG. 14, the search module 140 may use the similarity determination model 12 to measure degrees of similarity between natural language data 1410 related to a user input and each of the table catalogs 1311, 1321, and 1331 of the plurality of databases DB1 31, DB2 32, and DB3 33, and to select, based on the measured degrees of similarity, at least one of the databases DB1 31, DB2 32, and DB3 33 as a target database.

In this case, the natural language data 1410 related to the user input may include a natural language query related to an analysis history selected by the user 1 and a natural language query entered by the user 1. This is described in detail with reference to FIGS. 10 and 11. In FIG. 10, when the user 1 selects the analysis history 2 1020, the backend server 120 may extract the natural language query 1021 included in the analysis history 2 1020 and the natural language query 1011 included in the analysis history 1 1010, which is a higher layer above the analysis history 2 1020, for use in selecting a target database. When the user 1 selects the analysis history 2 1020 and then enters the natural language query 1131 into the input window 1130 of the UI screen 1100 of FIG. 11, the backend server 120 may request the search module 140 to select a target database while transmitting, to the search module 140, the natural language queries 1011 and 1021 respectively extracted from the analysis history 1 1010 and analysis history 2 1020 and the natural language query 1131 entered by the user 1.

In response to a request from the search module 140, the similarity determination model 12 may measure a similarity score between the natural language data 1410 related to the user input, which is received from the backend server 120, and each of the table catalogs 1311, 1321, and 1331 of the plurality of databases DB1 31, DB2 32, and DB3 33. Referring to FIG. 14, a similarity score measured by the similarity determination model 12 between the natural language data 1410 related to the user input and the table catalog 1311 of the database DB1 31 is 0.9586. A similarity score calculated between the natural language data 1410 related to the user input and the table catalogue 1321 of the database DB2 32 is 0.9784, and a similarity score calculated between the natural language data 1410 related to the user input and the table catalogue 1331 of the database DB3 33 is 0.4324.

The search module 140 may select, based on the calculated similarity scores, at least one of the plurality of databases DB1 31, DB2 32, and DB3 33 as a target database. The search module 140 may select a target database according to preset rules or criteria. For example, the search module 140 may select a database with a similarity score greater than a preset threshold as a target database. Alternatively, for example, the search module 140 may select a preset number of databases as target databases in a descending order of similarity scores. Alternatively, for example, the search module 140 may perform a normalization operation on the calculated similarity scores and then select a database with a similarity score greater than a preset threshold as a target database.

In the embodiment of the disclosure illustrated in FIG. 14, it is assumed that the search module 140 selects the databases DB1 31 and DB2 32 having similarity scores higher than a threshold (e.g., 0.8) as target databases. When the search module 140 has completed selecting the target database, the frontend server 110 and the backend server 120 may cause a result of the selection to be displayed on a screen of the user terminal 20.

According to one or more embodiments of the disclosure, the frontend server 110 and the backend server 120 may control a UI screen corresponding to the database selected by the search module 140 as the target database to be displayed on the user terminal 20. According to one or more embodiments of the disclosure, UI screens respectively corresponding to databases are illustrated in FIGS. 13A to 13C. However, information included in the UI screens corresponding to the databases, or layouts of the UI screens may be configured differently than those illustrated in FIGS. 13A to 13C.

As illustrated in FIG. 14, when the search module 140 selects the databases DB1 31 and DB2 32 as target databases, the frontend server 110 and the backend server 120 may control the UI screen 1310 corresponding to the database DB1 31 shown in FIG. 13A and the UI screen 1320 corresponding to the database DB2 32 shown in FIG. 13B to be displayed on the user terminal 20. The user 1 may view information about databases selected as target databases via the user terminal 20.

In addition, as described above, according to one or more embodiments of the disclosure, the frontend server 110 and the backend server 120 may also display UI screens corresponding to databases not selected by the search module 140 on the user terminal 20, thereby providing the user 1 with an opportunity to edit a target database. In this case, the backend server 120 may display selection results such that the databases selected by the search module 140 are distinguished from the databases not selected by the search module 140. For example, the backend server 120 may control a UI screen corresponding to a database selected by the search module 140 to be displayed more clearly than a UI screen corresponding to a database not selected by the search module 140.

The user 1 may exclude some of the databases selected by the search module 140 from the target database, or conversely, allow some of the databases not selected by the search module 140 to be included in the target database.

### 6. Generating a Prompt (for Generating an SQL Statement)

When selection of a target database is completed, the backend server 120 of the electronic device 200 may generate a prompt based on a user input and the target database. In this case, the generated prompt is a prompt for generating an SQL statement. That is, when the backend server 120 inputs a prompt generated based on the user input and the target database to the code generation model 11, the code generation model 11 may generate and output an SQL statement for performing data analysis.

The backend server 120 may generate a prompt based on the user input and the target database, and as described above, the user input may include only a natural language query, or may further include an input for selecting an analysis history.

When the user input includes an input for selecting an analysis history and a natural language query, the backend server 120 may generate a prompt, based on metadata of the target database, the natural language query contained in the user input, and the selected analysis history.

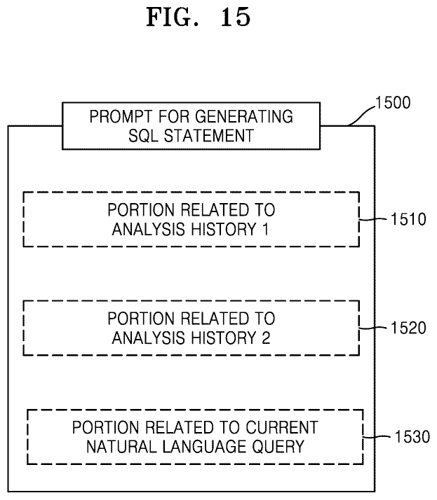

FIG. 15 illustrates an example structure of a prompt generated by the backend server 120 based on a user input (selection of an analysis history and a natural language query) and a target database. Referring to FIG. 15, a prompt 1500 may include a portion 1510 related to analysis history 1, a portion 1520 related to analysis history 2, and a portion 1530 related to a current natural language query.

As described above, when the user 1 selects the analysis history 2, data corresponding to the analysis history 1, which is a higher layer above the selected analysis history 2, may also be used when generating the prompt 1500.

The portion 1530 related to the current natural language query may refer to a portion generated using data related to the natural language query (the current natural language query) entered via the input window 1130 of FIG. 11.

When the user input received via the user terminal 20 does not include an input for selecting an analysis history but includes only a natural language query, the prompt 1500 may be configured to include only the portion 1530 related to the current natural language query.

According to one or more embodiments of the disclosure, the backend server 120 may generate an analysis history-related portion (e.g., the portion 1510 or 1520) by using metadata of a database related to a selected analysis history, a natural language query related to the selected analysis history, and an SQL statement related to the selected analysis history.

In this case, the database related to the selected analysis history may refer to a database used when performing at least one analysis task included in the selected analysis history.

Furthermore, the natural language query related to the selected analysis history may mean a natural language query entered when performing at least one analysis task included in the selected analysis history.

In addition, the SQL statement related to the selected analysis history may mean an SQL statement generated by the code generation model 11 when performing at least one analysis task included in the selected analysis history.

According to one or more embodiments of the disclosure, the backend server 120 may generate the portion 1530 related to the current natural language query by using metadata (table catalog and table schema) of the target database and the natural language query entered by the user 1.

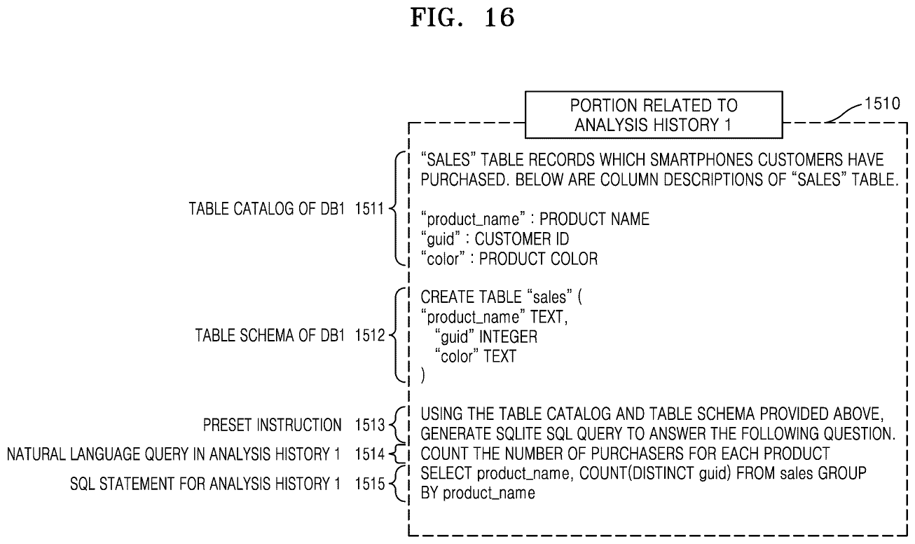

Hereinafter, a detailed configuration of the prompt 1500 is described in detail with reference to FIGS. 16 to 18.

FIG. 16 is a diagram illustrating details of the portion 1510 related to analysis history 1 included in the prompt 1500 of FIG. 15. Referring to FIG. 16, it can be seen that the portion 1510 related to the analysis history 1 includes data related to an analysis task of ‘counting the number of purchasers for each product’ (hereinafter referred to as a ‘first analysis task’).

Because the database DB1 31 was used when performing the first analysis task (e.g., the analysis task corresponding to the analysis history 1), the portion 1510 related to the analysis history 1 may include a table catalog 1511 of the database DB1 31 and a table schema 1512 of the database DB1 31.

Furthermore, the portion 1510 related to the analysis history 1 may include a preset instruction 1513. The preset instruction 1513 may be a text indicating an instruction ‘generate an SQL statement corresponding to a natural language query by referring to metadata of the database.’

Furthermore, the portion 1510 related to the analysis history 1 may include a natural language query 1514 in the analysis history 1 and an SQL statement 1515 for the analysis history 1. The natural language query 1514 in the analysis history 1 may be a natural language query entered when performing the first analysis task. Additionally, the SQL statement 1515 for the analysis history 1 may be an SQL statement generated by the code generation model 11 when performing the first analysis task.

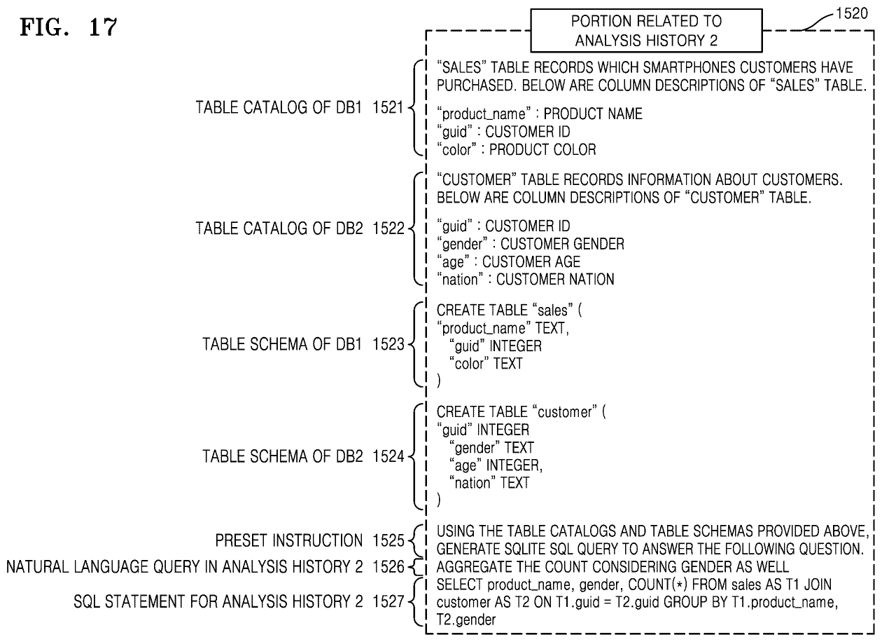

FIG. 17 is a diagram illustrating details of the portion 1520 related to analysis history 2 included in the prompt 1500 of FIG. 15. Referring to FIG. 17, it can be seen that the portion 1520 related to the analysis history 2 includes data related to an analysis task of ‘aggregating the count with additional consideration of gender’ (hereinafter referred to as a ‘second analysis task’). The second analysis task corresponds to an additional work performed using a result of performing the first analysis task.

Because the databases DB1 31 and DB2 32 were used when performing the second analysis operation (the analysis operation corresponding to the analysis history 2), the portion 1520 related to the analysis history 2 may include a table catalog 1521 of the database DB1 31, a table catalog 1522 of the database DB2 32, a table schema 1523 of the database DB1 31, and a table schema 1524 of the database DB2 32.

Furthermore, the portion 1520 related to the analysis history 2 may include a preset instruction 1525. The preset instruction 1525 may be a text instructing ‘generate an SQL statement corresponding to a natural language query by referring to metadata of the databases.’

Furthermore, the portion 1520 related to the analysis history 2 may include a natural language query 1526 for the analysis history 2 and an SQL statement 1527 for the analysis history 2. The natural language query 1526 in the analysis history 2 may be a natural language query entered when performing the second analysis task. Additionally, the SQL statement 1527 for the analysis history 2 may be an SQL statement generated by the code generation model 11 when performing the second analysis task.

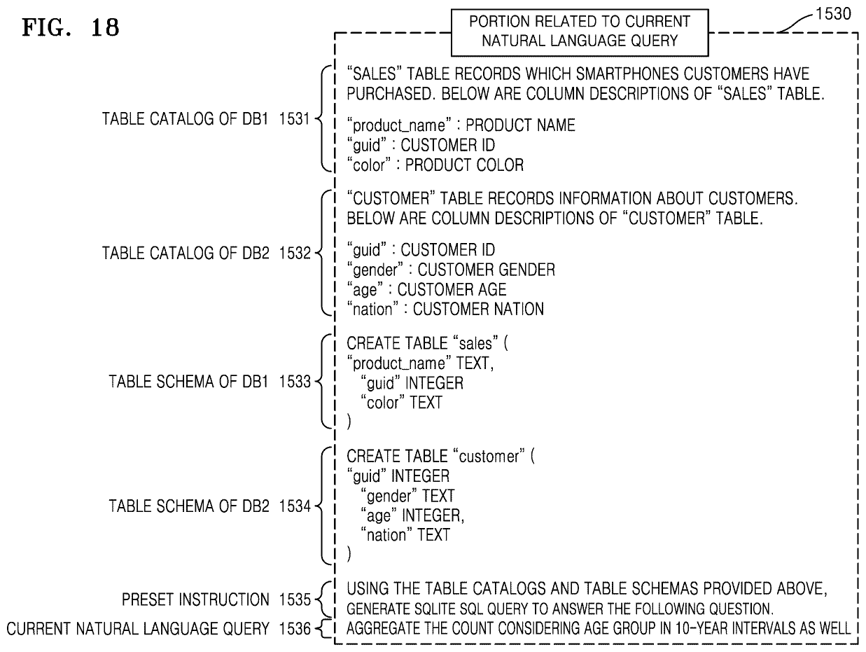

FIG. 18 is a diagram for explaining details of a portion related to the current natural language query included in the prompt 1500 of FIG. 15. Referring to FIG. 18, it can be seen that the portion 1530 related to the current natural language query includes metadata of the target database and a natural language query (current natural language query) entered by the user 1. In one or more examples, the metadata of the target database may be retrieved and appended to the natural language query to form a prompt.

Because the databases DB1 31 and DB2 32 are selected as target databases, the portion 1530 related to the current natural language query may include a table catalog 1531 of the database DB1 31, a table catalog 1532 of the database DB2 32, a table schema 1533 of the database DB1 31, and a table schema 1534 of the database DB2 32.

Furthermore, the portion 1530 related to the current natural language query may include a preset instruction 1535. The preset instruction 1535 may be a text instructing ‘generate an SQL statement corresponding to a natural language query by referring to metadata of the databases.’

Furthermore, the portion 1530 related to the current natural language query may include a current natural language query 1536. The current natural language query 1536 may be a natural language query entered by the user 1 via the input window 1130 of FIG. 11.

### 7. Obtaining an SQL Statement by Inputting a Generated Prompt to a Code Generation Model

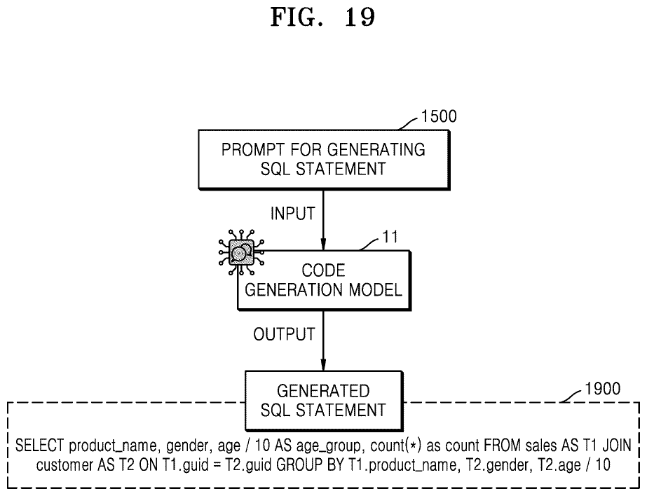

FIG. 19 is a diagram illustrating an example in which the code generation model 11 generates an SQL statement when a prompt is input to the code generation model 11 in the process of performing a data analysis method, according to one or more embodiments of the disclosure.

As shown in FIG. 19, when the backend server 120 inputs the prompt 1500 to the code generation model 11, the code generation model 11 may generate and output an SQL statement 1900 corresponding to the current natural language query 1536.

For example, the SQL statement 1900 output by the code generation model 11 in FIG. 19 is a code used to additionally perform a third analysis task (e.g., aggregating the count with additional consideration of an age group in 10-year intervals by using the results of performing the first analysis task (e.g., counting the number of purchasers for each product) and the second analysis task (e.g., aggregating the count with additional consideration of gender).

### 8. Performing Data Analysis by Executing an Obtained SQL Statement

The backend server 120 may perform data analysis by executing an SQL statement obtained from the code generation model 11. In one or more examples, the backend server 120 may execute the SQL statement on the database management system 130 to perform analysis on data stored in the databases DB1 31 and DB2 32 that are target databases, and may receive a result of the data analysis from the database management system 130.

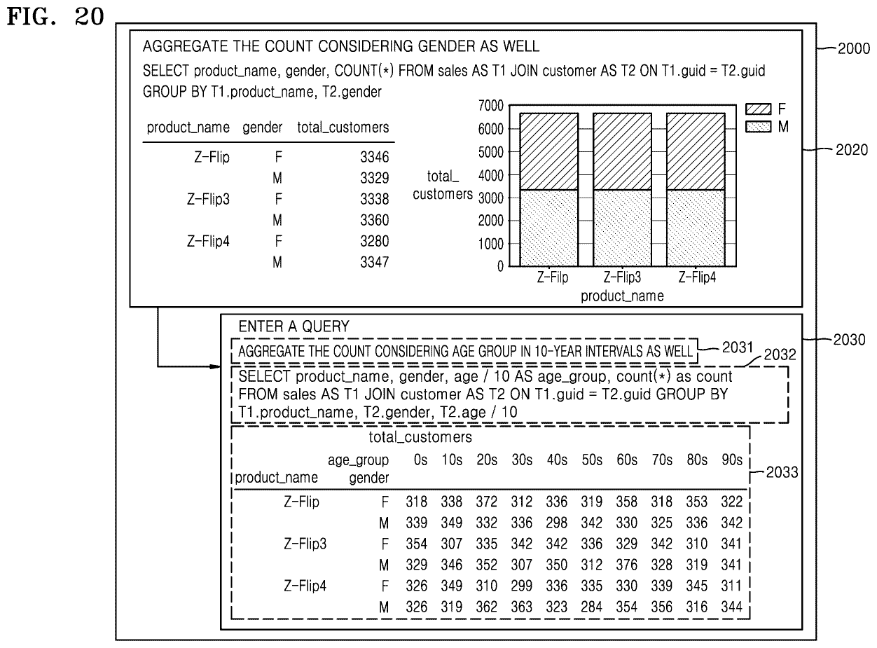

The frontend server 110 and the backend server 120 may display the result of the data analysis on the user terminal 20. FIG. 20 illustrates a UI screen that outputs a result of analyzing the data by executing the generated SQL statement.

Referring to FIG. 20, a fourth UI screen 2000 may display a result of executing a current nature language query 2031 in an input window 2030 for entering a natural language query, together with details of analysis history 2 2020. The input window 2030 may display a natural language query (the current natural language query 2031) previously entered by the user 1, followed by an SQL statement 2032 corresponding to the current natural language query 2031, and below that, a table 2033 indicating a result of performing data analysis according to the SQL statement 2032 may be displayed.

The fourth UI screen 2000 of FIG. 20 is only an example, and a UI screen showing a data analysis result may be configured in various layouts.

### 9. Visualizing and Outputting a Result of Data Analysis

According to one or more embodiments of the disclosure, the frontend server 110 and the backend server 120 may visualize a result of data analysis as a graph or chart and display the graph or chart on the user terminal 20.

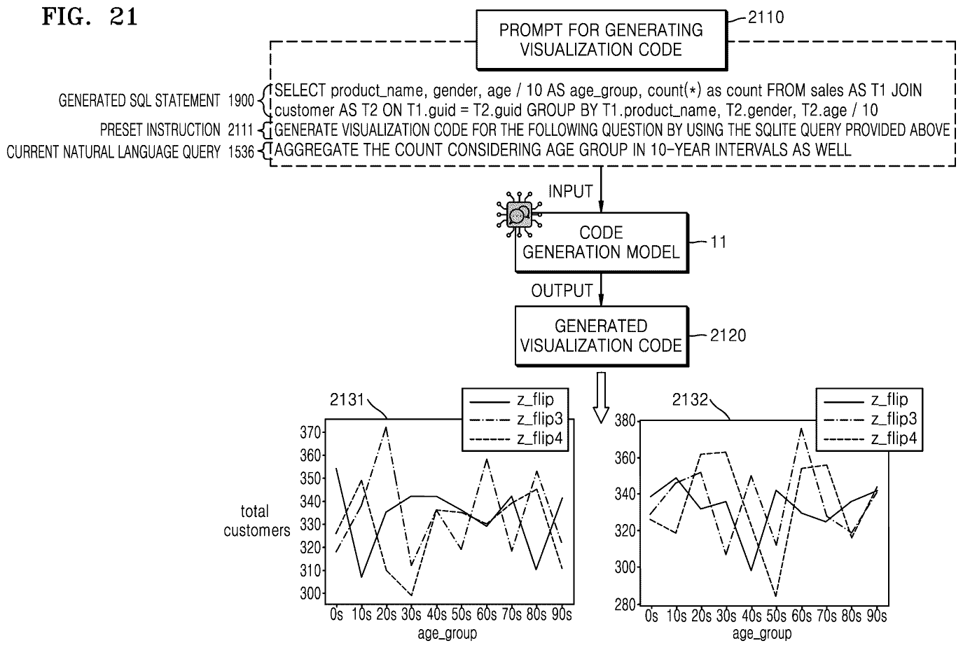

FIG. 21 illustrate a method of visualizing results of data analysis as graphs or charts in the process of performing a data analysis method, according to one or more embodiments of the disclosure. The backend server 120 may generate a prompt 2110 for generating visualization code by using a natural language query (a current natural language query) entered by the user 1 and a generated SQL statement. Referring to FIG. 21, the prompt 2110 for generating visualization code may include the SQL statement 1900 generated as described above with reference to FIG. 19, a preset instruction 2111, and the current natural language query 1536 included in the prompt 1500. The preset instruction 2111 may be a text indicating an instruction ‘write a visualization code for a natural language query by referring to the SQL statement.’

When the backend server 120 inputs a prompt 2110 for generating a visualization code to the code generation model 11, the code generation model 11 may generate and output a visualization code 2120.

When the backend server 120 executes the visualization code 2120 obtained from the code generation model 11, graphs and charts 2131 and 2132 that represent the results of data analysis according to the SQL statement 1900 may be generated. When the backend server 120 transmits the generated graphs and charts 2131 and 2132 to the frontend server 110, the frontend server 110 may display them on the screen of the user terminal 20.

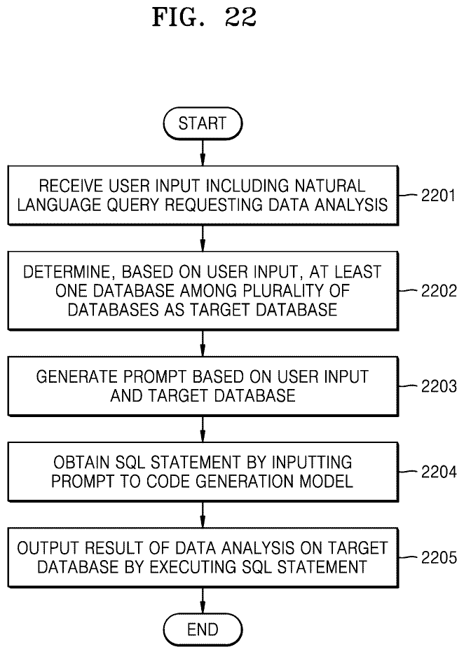

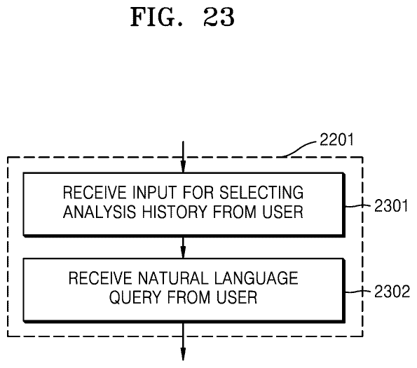

A method of performing data analysis according to a natural language query, according to embodiments of the disclosure, is described with reference to flowcharts of FIGS. 22 to 26. Because operations included in the flowcharts of FIGS. 22 to 26 are performed by the electronic device 200 of FIG. 1, descriptions already provided with reference to FIGS. 1 to 21 may be equally applicable to FIGS. 22 to 26 even when omitted below.

Referring to FIG. 22, in operation 2201, the electronic device 200 may receive a user input including a natural language query requesting data analysis. The user input may include only the natural language query, or may further include an input for selecting an analysis history. Detailed operations included in operation 2201 are illustrated in FIG. 23.

Referring to FIG. 23, in operation 2301, the electronic device 200 may receive an input for selecting an analysis history from the user. In detail, when the electronic device 200 outputs a UI screen for selecting an analysis history through the user terminal 20, the user 1 may select an analysis history to be reflected in data analysis via the UI screen.

In operation 2302, the electronic device 200 may receive a natural language query from the user.

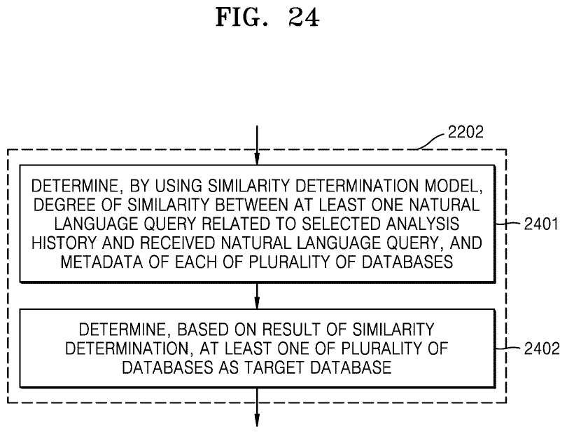

Referring back to FIG. 22, in operation 2202, the electronic device 200 may determine, based on the user input, at least one database among a plurality of databases as a target database. In detail, the electronic device 200 may determine a target database by using data related to the user input and metadata of the databases. In other words, the electronic device 200 may determine a target database to be used for analysis based on the analysis history selected by the user 1 and the natural language query entered by the user 1. Detailed operations included in operation 2202 are illustrated in FIG. 24.

Referring to FIG. 24, in operation 2401, the electronic device 200 may determine, by using a similarity determination model, a degree of similarity between at least one natural language query related to the selected analysis history and the received natural language query, and metadata of each of a plurality of databases. The similarity determination model may measure the degree of similarity as a similarity score and output the similarity score.

In operation 2402, the electronic device 200 may determine, based on a result of the similarity determination, at least one of the plurality of databases as a target database. As described above, the electronic device 200 may select the target database by comparing similarity scores with a preset threshold or selecting a certain number of databases in a descending order of similarity scores.

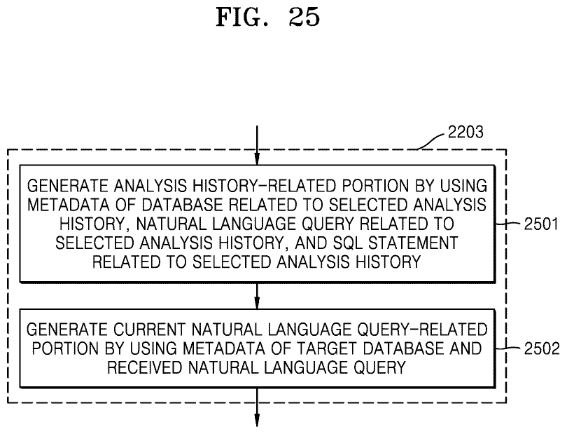

Referring back to FIG. 22, in operation 2203, the electronic device 200 may generate a prompt based on the user input and the target database. Detailed operations included in operation 2203 are illustrated in FIG. 25.

The prompt may include an analysis history-related portion and a current natural language query-related portion. In operation 2501, the electronic device 200 may generate the analysis history-related portion by using metadata of a database related to the selected analysis history, a natural language query related to the selected analysis history, and an SQL statement related to the selected analysis history. In operation 2502, the electronic device 200 may generate the current natural language query-related portion by using metadata of the target database and the received natural language query.

Referring back to FIG. 22, in operation 2204, the electronic device 200 may obtain an SQL statement by inputting the generated prompt to a code generation model.

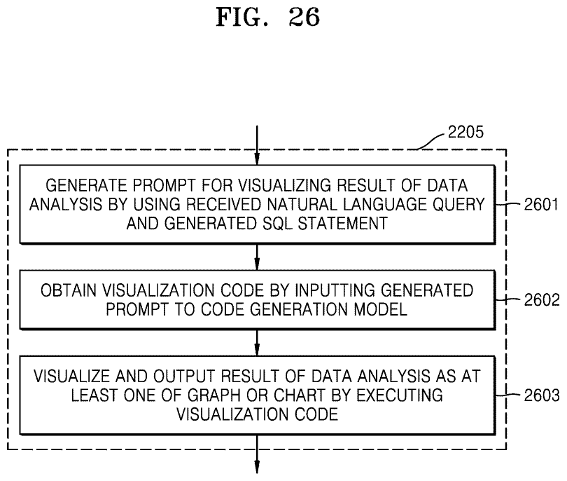

In operation 2205, the electronic device 200 may output a result of the data analysis on the target database by executing the SQL statement. According to one or more embodiments of the disclosure, the electronic device 200 may visualize and output a result of the data analysis as a graph or chart, and detailed operations of operation 2205 for this are illustrated in FIG. 26.

Referring to FIG. 26, in operation 2601, the electronic device 200 may generate a prompt for visualizing a result of the data analysis by using the received natural language query and the generated SQL statement.

In operation 2602, the electronic device 200 may obtain a visualization code by inputting the generated prompt to the code generation model.

In operation 2603, the electronic device 200 may visualize and output the result of the data analysis as at least one of a graph or a chart by executing the visualization code.

According to the embodiments of the disclosure described above, by performing data analysis according to a user's natural language query, it is possible for even users who do not know SQL syntax to easily analyze data, thereby improving user convenience and allowing more users to utilize data.

A method of performing data analysis according to a natural language query from a user, according to one or more embodiments of the disclosure, may include receiving, from a user terminal, a user input including the natural language query requesting the data analysis, determining, based on the user input, at least one database among a plurality of databases as a target database, generating a prompt based on the user input and the target database, inputting the prompt into a code generation model to obtain a structured query (SQL) statement, executing the SQL statement to generate a result of the data analysis on the target database, and transmitting the result of the data analysis to the user terminal, wherein the result of the data analysis is displayed on a screen of the user terminal.

According to one or more embodiments of the disclosure, the receiving of the user input may include receiving an input for selecting an analysis history from the user and receiving the natural language query from the user.

According to one or more embodiments of the disclosure, the determining of the at least one database as the target database may include determining, by using a similarity determination model, a degree of similarity between at least one natural language query related to the selected analysis history and the received natural language query and metadata of each of the plurality of databases, and determining, based on a result of the determining of the degree of similarity, at least one of the plurality of databases as the target database.

According to one or more embodiments of the disclosure, the metadata may include a table catalog and a table schema, wherein the table catalog may include a description of a table included in a database corresponding to the metadata and a description of each column in the table, and the table schema may define a structure and rules of the table included in the database corresponding to the metadata.

According to one or more embodiments of the disclosure, the prompt may include an analysis history-related portion and a current natural language query-related portion, and the generating of the prompt may include generating the analysis history-related portion by using metadata of a database related to the selected analysis history, a natural language query related to the selected analysis history, and an SQL statement related to the selected analysis history and generating the current natural language query-related portion by using metadata of the target database and the received natural language query.

According to one or more embodiments of the disclosure, the database related to the selected analysis history may be a database used in performing at least one analysis task included in the selected analysis history, the natural language query related to the selected analysis history may be a natural language query input in performing the at least one analysis task included in the selected analysis history, and the SQL statement related to the selected analysis history may be an SQL statement generated by the code generation model in performing the at least one analysis task included in the selected analysis history.

According to one or more embodiments of the disclosure, the analysis history-related portion and the current natural language query-related portion may each include an instruction to generate an SQL statement corresponding to a natural language query by referring to metadata of at least one database from the plurality of databases.

According to one or more embodiments of the disclosure, the analysis history may include at least one analysis task previously performed on at least one database among the plurality of databases.

According to one or more embodiments of the disclosure, the outputting of the result of the data analysis may include generating a prompt for visualizing the result of the data analysis by using the received natural language query and the generated SQL statement, obtaining a visualization code by inputting the prompt for visualizing the result of the data analysis to the code generation model, and visualizing and outputting the result of the data analysis as at least one of a graph or a chart by executing the visualization code.

According to one or more embodiments of the disclosure, the prompt for visualizing the result of the data analysis may include an instruction to generate the visualization code corresponding to the received natural language query by referring to the generated SQL statement.

An electronic device for performing data analysis according to a natural language query from a user, according to one or more embodiments of the disclosure, may include memory storing one or more instructions, and at least one processor operatively coupled to the memory, wherein the one or more instructions, when executed by the at least one processor, cause the electronic device to receive, from a user terminal, a user input including the natural language query requesting the data analysis, determine, based on the user input, at least one database among a plurality of databases as a target database, generate a prompt based on the user input and the target database, input the prompt into a code generation model to obtain an SQL statement, execute the SQL statement to generate a result of the data analysis on the target database, and transmit the result of the data analysis to the user terminal, wherein the result of the data analysis is displayed on a screen of the user terminal.

According to one or more embodiments of the disclosure, the one or more instructions when executed by the at least one processor, cause the electronic device, in the receiving of the user input, to receive an input for selecting an analysis history from the user and then receive the natural language query from the user.

According to one or more embodiments of the disclosure, the one or more instructions when executed by the at least one processor, cause the electronic device, in the determining of the at least one database as the target database, to determine, by using a similarity determination model, a degree of similarity between at least one natural language query related to the selected analysis history and the received natural language query and metadata of each of the plurality of databases and then determine, based on a result of the determining of the degree of similarity, at least one of the plurality of databases as the target database.

According to one or more embodiments of the disclosure, the metadata may include a table catalog and a table schema, wherein the table catalog may include a description of a table included in a database corresponding to the metadata and a description of each column in the table, and the table schema may define a structure and rules of the table included in the database corresponding to the metadata.

According to one or more embodiments of the disclosure, the prompt may include an analysis history-related portion and a current natural language query-related portion, and the one or more instructions when executed by the at least one processor, cause the electronic device, in the generating of the prompt, to generate the analysis history-related portion by using metadata of a database related to the selected analysis history, a natural language query related to the selected analysis history, and an SQL statement related to the selected analysis history, and then generate the current natural language query-related portion by using metadata of the target database and the received natural language query.

According to one or more embodiments of the disclosure, the database related to the selected analysis history may be a database used in performing at least one analysis task included in the selected analysis history, the natural language query related to the selected analysis history may be a natural language query input in performing the at least one analysis task included in the selected analysis history, and the SQL statement related to the selected analysis history may be an SQL statement generated by the code generation model in performing the at least one analysis task included in the selected analysis history.

According to one or more embodiments of the disclosure, the analysis history-related portion and the current natural language query-related portion may each include an instruction to generate an SQL statement corresponding to a natural language query by referring to metadata of at least one database from the plurality of databases.

According to one or more embodiments of the disclosure, the analysis history may include at least one analysis task previously performed on at least one database among the plurality of databases.

According to one or more embodiments of the disclosure, the one or more instructions when executed by the at least one processor, cause the electronic device, in the outputting of the result of the data analysis, to generate a prompt for visualizing the result of the data analysis by using the received natural language query and the generated SQL statement, obtain a visualization code by inputting the prompt for visualizing the result of the data analysis to the code generation model, and visualize and output the result of the data analysis as at least one of a graph or a chart by executing the visualization code.

Various embodiments of the disclosure may be implemented or supported by one or more computer programs that may be created from computer-readable program code and included on computer-readable media. As used herein, the terms “application” and “program” may refer to one or more computer programs, software components, instruction sets, procedures, functions, objects, classes, instances, associated data, or parts thereof suitable for implementation in computer-readable program code. The “computer-readable program code” may include various types of computer code, including source code, object code, and executable code. The “computer-readable media” may include various types of media that are accessible by a computer, such as ROM, RAM, hard disk drives (HDDs), CDs, DVDs, or various other types of memory.

Furthermore, a machine-readable storage medium may be provided in the form of a non-transitory storage medium. Here, the “non-transitory storage medium” is a tangible device and may exclude wired, wireless, optical, or other communication links that transmit transient electrical or other signals. Moreover, the term “non- transitory storage medium” does not differentiate between where data is semi- permanently stored in the storage medium and where the data is temporarily stored in the storage medium. For example, the ‘non-transitory storage medium’ may include a buffer for temporarily storing data. The computer-readable media may be any available media that are accessible by a computer and include both volatile and nonvolatile media and both removable and non-removable media. The computer-readable media include media on which data may be permanently stored and media on which data may be stored and overwritten later, such as rewritable optical disks or erasable memory devices.

According to one or more embodiments of the disclosure, methods according to various embodiments of the disclosure set forth herein may be included in a computer program product when provided. The computer program product may be traded, as a product, between a seller and a buyer. The computer program product may be distributed in the form of a machine-readable storage medium (e.g., compact disc ROM (CD-ROM)) or distributed (e.g., downloaded or uploaded) on-line via an application store or directly between two user devices (e.g., smartphones). For online distribution, at least a part of the computer program product (e.g., a downloadable app) may be at least transiently stored or temporally generated in the machine-readable storage medium such as memory of a server of a manufacturer, a server of an application store, or a relay server.

The above description of the disclosure is provided for illustration, and it will be understood by those of ordinary skill in the art that changes in form and details may be readily made therein without departing from technical idea or essential characteristics of the disclosure. For example, adequate effects may be achieved even when the above-described techniques are performed in a different order than that described above, and/or the aforementioned components of the systems, structures, devices, circuits, etc. are coupled or combined in different forms and modes than those described above or are replaced or supplemented by other components or their equivalents. Accordingly, the above-described embodiments of the disclosure and all aspects thereof are merely examples and are not limiting. For example, each component defined as an integrated component may be implemented in a distributed fashion, and likewise, components defined as separate components may be implemented in an integrated form.

The scope of the disclosure is defined not by the detailed description thereof but by the following claims, and all the changes or modifications within the meaning and scope of the appended claims and their equivalents will be construed as being included in the scope of the disclosure.

1. A method of performing data analysis according to a natural language query from a user, the method comprising:
receiving, from a user terminal, a user input including the natural language query requesting the data analysis;
determining, based on the user input, at least one database among a plurality of databases as a target database;
generating a prompt based on the user input and the target database;
inputting the prompt into a code generation model to obtain a structured query (SQL) statement;
executing the SQL statement to generate a result of the data analysis on the target database; and
transmitting the result of the data analysis to the user terminal,
wherein the result of the data analysis is displayed on a screen of the user terminal.

2. The method of claim 1, wherein the receiving of the user input comprises:
receiving an input for selecting an analysis history from the user; and
receiving the natural language query from the user.

3. The method of claim 2, wherein the determining of the at least one database as the target database comprises:
determining, by using a similarity determination model, a degree of similarity between at least one natural language query related to the selected analysis history and the received natural language query and metadata of each of the plurality of databases; and
determining, based on a result of the determining of the degree of similarity, at least one of the plurality of databases as the target database.

4. The method of claim 3, wherein
the metadata comprises a table catalog and a table schema,
the table catalog comprises a description of a table included in a database corresponding to the metadata and a description of each column in the table, and
the table schema defines a structure and rules of the table included in the database corresponding to the metadata.

5. The method of claim 2, wherein
the prompt comprises an analysis history-related portion and a current natural language query-related portion, and
the generating of the prompt comprises:
generating the analysis history-related portion by using metadata of a database related to the selected analysis history, a natural language query related to the selected analysis history, and an SQL statement related to the selected analysis history; and
generating the current natural language query-related portion by using metadata of the target database and the received natural language query.

6. The method of claim 5, wherein
the database related to the selected analysis history is a database used in performing at least one analysis task included in the selected analysis history,
the natural language query related to the selected analysis history is a natural language query input in performing the at least one analysis task included in the selected analysis history, and
the SQL statement related to the selected analysis history is an SQL statement generated by the code generation model in performing the at least one analysis task included in the selected analysis history.

7. The method of claim 5, wherein each of the analysis history-related portion and the current natural language query-related portion comprises an instruction to generate an SQL statement corresponding to a natural language query by referring to metadata of at least one database from the plurality of databases.

8. The method of claim 2, wherein the analysis history comprises at least one analysis task previously performed on at least one database among the plurality of databases.

9. The method of claim 1, wherein the outputting of the result of the data analysis comprises:
generating a prompt for visualizing the result of the data analysis by using the received natural language query and the generated SQL statement;
obtaining a visualization code by inputting the prompt for visualizing the result of the data analysis to the code generation model; and
visualizing and outputting the result of the data analysis as at least one of a graph or a chart by executing the visualization code.

10. The method of claim 9, wherein the prompt for visualizing the result of the data analysis comprises an instruction to generate the visualization code corresponding to the received natural language query by referring to the generated SQL statement.

11. A non-transitory computer-readable storage medium having instructions stored therein, which when executed by a processor, cause the processor to execute a method comprising:
receiving, from a user terminal, a user input including the natural language query requesting the data analysis;
determining, based on the user input, at least one database among a plurality of databases as a target database;
generating a prompt based on the user input and the target database;
inputting the prompt into a code generation model to obtain a structured query (SQL) statement;
executing the SQL statement to generate a result of the data analysis on the target database; and
transmitting the result of the data analysis to the user terminal,
wherein the result of the data analysis is displayed on a screen of the user terminal.

12. An electronic device for performing data analysis according to a natural language query from a user, the electronic device comprising:
memory storing one or more instructions; and
at least one processor operatively coupled to the memory,
wherein the one or more instructions, when executed by the at least one processor, cause the electronic device to:
receive, from a user terminal, a user input including the natural language query requesting the data analysis,
determine, based on the user input, at least one database among a plurality of databases as a target database,
generate a prompt based on the user input and the target database,
input the prompt into a code generation model to obtain a structured query (SQL) statement,
execute the SQL statement to generate a result of the data analysis on the target database; and
transmit the result of the data analysis to the user terminal,
wherein the result of the data analysis is displayed on a screen of the user terminal.

13. The electronic device of claim 12, wherein the one or more instructions, when executed by the at least one processor, cause the electronic device, in receiving the user input, to:
receive an input for selecting an analysis history from the user, and
receive the natural language query from the user.

14. The electronic device of claim 13, wherein the one or more instructions, when executed by the at least one processor, cause the electronic device, in determining the at least one database as the target database, to:
determine, by using a similarity determination model, a degree of similarity between at least one natural language query related to the selected analysis history and the received natural language query and metadata of each of the plurality of databases, and
determine, based on a result of the determining of the degree of similarity, at least one of the plurality of databases as the target database.

15. The electronic device of claim 14, wherein
the metadata comprises a table catalog and a table schema, and
the table catalog comprises a description of a table included in a database corresponding to the metadata and a description of each column in the table, and
the table schema defines a structure and rules of the table included in the database corresponding to the metadata.

16. The electronic device of claim 13, wherein
the prompt comprises an analysis history-related portion and a current natural language query-related portion, and
wherein the one or more instructions, when executed by the at least one processor, cause the electronic device, in the generating of the prompt, to:
generate the analysis history-related portion by using metadata of a database related to the selected analysis history, a natural language query related to the selected analysis history, and an SQL statement related to the selected analysis history, and
generate the current natural language query-related portion by using metadata of the target database and the received natural language query.

17. The electronic device of claim 16, wherein
a database related to the selected analysis history is a database used in performing at least one analysis task included in the selected analysis history,
the natural language query related to the selected analysis history is a natural language query input in performing the at least one analysis task included in the selected analysis history, and
the SQL statement related to the selected analysis history is an SQL statement generated by the code generation model in performing the at least one analysis task included in the selected analysis history.

18. The electronic device of claim 16, wherein each of the analysis history-related portion and the current natural language query-related portion comprises an instruction to generate an SQL statement corresponding to a natural language query by referring to metadata of at least one database from the plurality of databases.

19. The electronic device of claim 13, wherein the analysis history comprises at least one analysis task previously performed on at least one database among the plurality of databases.

20. The electronic device of claim 12, wherein the one or more instructions, when executed by the at least one processor, cause the electronic device, in the outputting of the result of the data analysis, to:
generate a prompt for visualizing the result of the data analysis by using the received natural language query and the generated SQL statement,
obtain a visualization code by inputting the prompt for visualizing the result of the data analysis to the code generation model, and
visualize and output the result of the data analysis as at least one of a graph or a chart by executing the visualization code.
